(19) United States
(12) Patent Application Publication
(10) Pub. No.: US 2019/0216067 A1
(43) Pub. Date: Jul. 18, 2019

(54) GLO-SHOT SPOON AND JIG

(71) Applicant: Eric Naig, Bemidji, MN (US)

(72) Inventor: Eric Naig, Bemidji, MN (US)

(21) Appl. No.: 16/106,816

(22) Filed: Aug. 21, 2018

Related U.S. Application Data
(60) Provisional application No. 62/617,427, filed on Jan. 15, 2018.

(51) Int. Cl. A01K 85/01; A01K 85/14; A01K 97/00; F21K 2/06

(52) U.S. Cl. CPC A01K 85/01; F21K 2/06; A01K 97/00; A01K 85/14

(57) ABSTRACT

The one or more embodiments of a glow in the dark fishing lure system are presented. The glow in the dark fishing lure system includes a main body having a receiving member therein that is sized and shaped to receive and hold a light member therein that in one arrangement is a glow stick. The light member is easily inserted into the receiving member by applying pressure to the light member thereby forcing the light member within the receiving member. The light member is easily removed from the receiving member by inserting a protrusion of a removal tool into the receiving member thereby forcing the light member out of the receiving member.

### CROSS REFERENCE TO PRIOR APPLICATION

This application is a utility patent application which claims priority from U.S. Provisional Application No. 62/617,427 filed Jan. 15, 2018.

### FIELD OF THE DISCLOSURE

This disclosure relates generally to fishing lures. More specifically and without limitation, this disclosure relates to a glow in the dark fishing lure system.

### BACKGROUND OF THE DISCLOSURE

Fishing lures are old and well known in the art. Countless forms of fishing lures exist in various sizes, shapes and designs. Each unique fishing lure configuration has its own unique operational characteristics and provides its own unique portfolio of advantages.

With the advent of glow in the dark paint, also known as phosphorescent paint or luminous paint, various attempts have been made to utilize glow in the dark paint in association with fishing lures. However, these attempts to utilize glow in the dark paints in association with fishing lures have largely been a failure.

This ineffectiveness is largely because, even under the best conditions, when a fishing lure is coated with a glow in the dark paint the resulting fishing lure barely glows. Under many conditions, the resulting glow is not even perceptible. Making matters worse, this glow diminishes over the short term when the lure is no longer exposed to light. In some cases, the glow from the glow in the dark paint may completely diminish within only a matter of minutes. Complicating matters further, the glow may be diminished further by environmental conditions, such as use in cold water (such as when fishing in deep water, cold bodies of water and/or when ice-fishing).

To combat the minimal amount of glow provided by glow in the dark painted fishing lures and the often-challenging fishing conditions users have attempted to “charge” the glow in the dark painted fishing lure prior to use. This is accomplished by exposing the fishing lure to high-intensity light just prior to use, such as by shining a bright flashlight on the lure, flashing the lure with a strobe light, or holding the lure up to the sun or another light source. “Charging” the lure in this manner does increase the intensity of glow of the glow in the dark paint. However, this increased glow tends to diminish quickly thereby reducing the effectiveness of this process. In addition, this process is inconvenient and it takes time away from fishing. This process is also cumbersome, as the user must grasp the fishing lure in one hand while holding the light source in the other hand and followed by holding the light source within close proximity to the lure, sometimes for a prolonged period of time. This process is also dangerous and exposes the user to an increased risk of injury as the user must grasp the lure, which inherently has sharp hooks associated with it, while the user charges the lure with the light source. As such, needing to repeatedly charge the fishing lure is undesirable.

Furthermore, it has not been proven that using a fishing lure with glow in the dark paint causes any increase in the amount of fish caught. Lack of effectiveness may likely be due to the minimal amount of glow provided by the glow in the dark paint.

Therefore, for all the reasons stated above, and the reasons stated below, there is a need in the art for a glow in the dark fishing lure system that improves upon the state of the art.

Another object of the disclosure is to provide a glow in the dark fishing lure system that provides a bright glow that attracts fish.

Yet, another object of the disclosure is to provide a glow in the dark fishing lure system that increases the amount of fish caught.

Another object of the disclosure is to provide a glow in the dark fishing lure system that glows for a long period of time.

Yet, another object of the disclosure is to provide a glow in the dark fishing lure system that can be used in various environmental conditions, such as cold water, while effectively operating.

Another object of the disclosure is to provide a glow in the dark fishing lure system that is easy to use.

Yet, another object of the disclosure is to provide a glow in the dark fishing lure system that is safe to use.

Another object of the disclosure is to provide a glow in the dark fishing lure system that does not require the user to repeatedly grasp the fishing lure for recharging using a light source.

Yet, another object of the disclosure is to provide a glow in the dark fishing lure system that has a long useful life.

Another object of the disclosure is to provide a glow in the dark fishing lure system that can be effectively used for ice fishing.

Yet, another object of the disclosure is to provide a glow in the dark fishing lure system that is relatively inexpensive.

Another object of the disclosure is to provide a glow in the dark fishing lure system that allows for the simple and easy replacement of a glow in the dark cartridge.

Yet, another object of the disclosure is to provide a glow in the dark fishing lure system that is fun to use.

Another object of the disclosure is to provide a glow in the dark fishing lure system that shines with a brilliant light.

Yet, another object of the disclosure is to provide a glow in the dark fishing lure system that can be used with various fishing lure sizes, shapes and configurations.

Another object of the disclosure is to provide a glow in the dark fishing lure system that can be modified to illuminate with any of a number of colors by simply changing a cartridge.

Yet, another object of the disclosure is to provide a glow in the dark fishing lure system that can brightly shine for hours.

Another object of the disclosure is to provide a glow in the dark fishing lure system that improves over existing glow in the dark fishing lures.

Yet, another object of the disclosure is to provide a glow in the dark fishing lure system that is strong and robust.

Another object of the disclosure is to provide a glow in the dark fishing lure system that can be used in many applications.

Yet, another object of the disclosure is to provide a glow in the dark fishing lure system that provides unique functionality.

Another object of the disclosure is to provide a glow in the dark fishing lure system that is fast to use.

Yet, another object of the disclosure is to provide a glow in the dark fishing lure system that saves time.

Another object of the disclosure is to provide a glow in the dark fishing lure system that has a compact size.

Yet, another object of the disclosure is to provide a glow in the dark fishing lure system that has a low profile.

Another object of the disclosure is to provide a glow in the dark fishing lure system that is high quality.

Yet, another object of the disclosure is to provide a glow in the dark fishing lure system that improves efficiencies.

Another object of the disclosure is to provide a glow in the dark fishing lure system that improves enjoyment.

These and other objects, features, or advantages of the disclosure will become apparent from the specification, figures and claims.

### BRIEF DESCRIPTION OF THE DRAWINGS

FIG. 1 is a perspective view of a top side of the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 2 is a perspective view of a bottom side of the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 3 is an elevation view of a top side of the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 4 is an elevation view of a bottom side of the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 5 is an elevation view of a first side of the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 6 is an elevation view of a second side of the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 7 is an elevation view of a top end of the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 8 is an elevation view of a bottom end the glow in the dark spoon fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 9 is an elevation cut-away view of the glow in the dark spoon fishing lure with a slot that receives a glow in the dark cartridge that is in the form of a miniaturized glow stick, the view along line 9 in FIG. 4 and showing the features of the slot in the body of the fishing lure;

FIG. 10 is an elevation cut-away view of the glow in the dark spoon fishing lure with a slot that receives a glow in the dark cartridge that is in the form of a miniaturized glow stick, the view along line 10 in FIG. 6 and showing the features of the slot in the body of the fishing lure;

FIG. 11 is a perspective view of a top side of the glow in the dark spoon fishing lure with a slot that receives a glow in the dark cartridge that is in the form of a miniaturized glow stick, the view showing the cartridge positioned within the slot of the main body;

FIG. 12 is a perspective view of a bottom side of the glow in the dark spoon fishing lure with a slot that receives a glow in the dark cartridge that is in the form of a miniaturized glow stick, the view showing the cartridge positioned within the slot of the main body;

FIG. 13 is an elevation view of a top side of the glow in the dark spoon fishing lure with a slot that receives a glow in the dark cartridge that is in the form of a miniaturized glow stick;

FIG. 14 is an elevation view of a bottom side of the glow in the dark spoon fishing lure with a slot that receives a glow in the dark cartridge that is in the form of a miniaturized glow stick, the view showing the cartridge positioned within the slot of the main body;

FIG. 15 is an elevation view of a first side of the glow in the dark spoon fishing lure with a slot that receives a glow in the dark cartridge that is in the form of a miniaturized glow stick;

FIG. 16 is an elevation view of a second side of the glow in the dark spoon fishing lure with a slot that receives a glow in the dark cartridge that is in the form of a miniaturized glow stick;

FIG. 17 is an elevation view of a top end of the glow in the dark spoon fishing lure with a slot that receives a glow in the dark cartridge that is in the form of a miniaturized glow stick;

FIG. 18 is an elevation view of a bottom end of the glow in the dark spoon fishing lure with a slot that receives a glow in the dark cartridge that is in the form of a miniaturized glow stick;

FIG. 19 is an elevation cut-away view of the glow in the dark spoon fishing lure with a slot that receives a glow in the dark cartridge that is in the form of a miniaturized glow stick, the view along line 19 in FIG. 16 the view showing the cartridge positioned within the slot of the main body and held between a lip at the upper end of the slot and fingers at the lower end of the slot;

FIG. 20 is a perspective view of a top front side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 21 is an elevation view of a front side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 22 is an elevation view of a rear side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 23 is an elevation view of a right side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 24 is an elevation view of a left side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 25 is an elevation view of a top side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 26 is an elevation view of a bottom side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 27 is a perspective view of a top rear side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 28 is a perspective view of a bottom rear side of the glow in the dark jig fishing lure with a slot that receives a glow in the dark cartridge that is in the form of a miniaturized glow stick, the view showing the cartridge removed from the slot, the view showing a connector for connecting the cartridge to a hook or other object and the view showing a removal tool for removing the cartridge from the slot in the fishing lure;

FIG. 29 is a perspective view of a top rear side of the glow in the dark jig fishing lure with a slot that receives a glow in the dark cartridge that is in the form of a miniaturized glow stick, the view showing the cartridge positioned within the slot of the main body;

FIG. 30 is a perspective view of a bottom rear side of the glow in the dark jig fishing lure with a slot that receives a glow in the dark cartridge that is in the form of a miniaturized glow stick, the view showing the cartridge positioned within the slot of the main body.

### SUMMARY OF THE DISCLOSURE

The one or more embodiments of a glow in the dark fishing lure system are presented. The glow in the dark fishing lure system includes a main body having a receiving member therein that is sized and shaped to receive and hold a light member therein that in one arrangement is a glow stick. The light member is easily inserted into the receiving member by applying pressure to the light member thereby forcing the light member within the receiving member. The light member is easily removed from the receiving member by inserting a fin of a removal tool into the slot of the receiving member thereby forcing the light member out of the receiving member.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the disclosure.

### System

With reference to the figures, a glow in the dark fishing lure system 10 (or simply system 10) is presented. The glow in the dark fishing lure system 10 is formed of any suitable size, shape and design and is configured to glow and attract fish and catch fish. In the arrangement shown, as one example, the glow in the dark fishing lure system 10 includes: a lure 12, the lure 12 having a main body 14, a front side 16, a back side 18, a top side 20, a bottom side 22, a left side 24, a right side 26, a receiving member 28 having a slot 30, a stop member 32, at least one finger 34, a collar 36; a feature 38, and a pair of openings 40, among other features; a light member 42, the light member 42 having a main body 44, a sidewall 46 and opposing ends 48, among other features; a removal tool 50, the removal tool 50 having a main body 52 having a top side 54, a bottom side 56 and a fin 58, among other features; and a connector 60, the connector 60 having a main body 62 having an opening 64 and an arm 66 having an opening 68, among other features; rings 70 and at least one hook member 72, among other features and components.

### Lure

With reference to the figures, a lure 12 is presented. Lure 12 is formed of any suitable size, shape and design and is configured to attract and catch fish. In the arrangement shown, as one example, lure 12 includes a main body 14 that takes the form of what is commonly known as a spoon in fishing lure vernacular. As another example, in the arrangement shown, lure 12 includes a main body 14 that takes the form of what is commonly known as a jig in fishing lure vernacular.

Main Body: In one arrangement, main body 14 is formed of a single solid monolith member that is formed by any manufacturing process such as machining, molding, casting, 3D printing, pressing, cutting, sintering, or any other manner or method of manufacturing main body. In an alternative arrangement, main body 14 is formed of multiple components or pieces that are joined together to form a single member such as adhering, gluing, snap-fitting, welding, or by connecting by any other manner, method or means; this single member may be a single solid member, or it may be a single member that is movable by connection through one or more joints, or the like.

In one arrangement, as one example, main body 14 has a front side 16 and a back side 18, that extend in approximate parallel spaced relation to one another, a top side 20 and a bottom side 22 that are positioned on opposing ends of the main body 14, and a left side 24 and a right side 26 that form opposing sides of the main body 14.

In one arrangement, as one example, main body 14, when viewed from left side 24 or right side 26, curves slightly from top side 20 to bottom side 22. In one arrangement, this curvature is continuous and constant from top side 20 to bottom side 22. In another arrangement, as is shown, as one example, this curve is more pronounced midway between top side 20 to bottom side 22, and/or midway between the top and bottom ends of slot 30. In the arrangement shown, as one example, the front side 16 is convex in shape whereas the opposing back side 18 is concave in shape. Any other shape, configuration or design of curvature is hereby contemplated for use.

In one arrangement, as one example, main body 14, when viewed from front side 16 or back side 18, terminates in a rounded upper end at top side 20 and terminates in a rounded lower end a bottom side 22. Also, when viewed from front side 16 or back side 18 opposing left side 24 and right side 16 extend in a generally straight manner from top side 20 to bottom side 22, however left side 24 and right side 26 angle slightly away from one another as they extend from top side 20 to bottom side 22. In this way, the upper end of main body 14 is slightly narrower from side-to-side than the lower end of main body 14. As such, the rounded upper end at top side 20 has a curvature with a smaller diameter than the rounded lower end at bottom side 22 which has a curvature with a larger diameter.

In one arrangement, as one example, main body 14 includes an opening 40 positioned adjacent the upper end of main body 14 at top side 20. Opening 40 is generally centrally positioned within the upper end of main body 14 and is formed of a circular shape that extends from front side 16 to back side 18, however any other shape is hereby contemplated for use. Similarly, main body 14 includes an opening 40 positioned adjacent the lower end of main body 14 at bottom side 22. Opening 40 is generally centrally positioned within the lower end of main body 14 and is formed of a circular shape that extends from front side 16 to back side 18, however any other shape is hereby contemplated for use. Openings 40 receive rings 70, which may be solid rings, or may be what are known as split rings or key rings therein. In one arrangement, as one example, ring 70 connected to the opening 40 positioned at the upper end of main body 14 is configured to be tied to by fishing line. In one arrangement, as one example, ring 70 connected to the opening 40 positioned at the lower end of main body 14 is configured to connect to hook 72, either directly or by connection to a second ring 70.

In one arrangement, as one example, the front side 16 of main body 14 is generally flat and smooth while following the shape and curvature of main body 14. In one arrangement, as one example, front side 16 trails or at its edges, such as left side 24, right side 26, top side 20, bottom side 22 and slot 30 such that the main body 14 is free of sharp corners that could cut fishing line for example. Front side 16 includes features of receiving member 28 therein such as slot 30 as is further described herein.

Similar to front side 16, in one arrangement, as one example, the back side 18 of main body 14 is generally flat and smooth while following the shape and curvature of main body 14. In one arrangement, as one example, back side 18 trails or at its edges, such as left side 24, right side 26, top side 20, bottom side 22 and slot 30 such that the main body 14 is free of sharp corners that could cut fishing line for example. Back side 18 includes features of receiving member 28 therein such as slot 30, stop member 32, and fingers 34 as is further described herein.

In one arrangement, main body 14 may be formed of a solid metallic material, which provides weight that is beneficial in fishing, such as lead, tungsten, brass, copper, iron, steel, aluminum, any ferrous material, any metallic alloy, or the like. In another arrangement, main body 14 is made of a non-metallic material, such as a plastic material, a composite material, an ultra-high-molecular-weight (UHMW) material or any other non-metallic material, which may be opaque, transparent, semi-transparent, translucent, clear, or any combination thereof (e.g. with portions that are opaque and with portions that are clear, or the like). Main body 14 may be formed of any other size, shape or design.

Receiving Member: In one arrangement, main body 14 includes a receiving member 28. Receiving member 28 is formed of any suitable size, shape and design and is configured to receive and hold light member 42. In one arrangement, as one example, receiving member 28 includes an opening or slot 30 that extends through front side 16 and back side 18 of main body 14. In the arrangement shown, as one example, when viewed from the front side 16, slot 30 includes opposing rounded ends 74 that are generally circular in shape or form a partial portion of a circle when viewed from front side 16. The outward edges of rounded ends 74 connect to opposing sidewalls 76. Sidewalls 76 extend in approximate parallel spaced relation to one another between rounded ends 74 thereby forming a generally flat and straight opening, or slot, in main body 14.

In the arrangement shown, as one example, slot 30 extends a length between opposing ends 74 the length of slot 30 is aligned to extend in approximate parallel relation with and centered upon the length of main body 14 between top side 20 and bottom side 22. This alignment provides main body 14 with balance. However any other alignment and arrangement is hereby contemplated for use.

In the arrangement shown, as one example, slot 30 extends a length between opposing ends 74 that only occupies a portion of the length of main body 14. In one arrangement, as one example, the length of slot 30 is approximately half the length of main body 14 from top side 20 to bottom side 22, however any other ratio or length is hereby contemplated such as approximately all of the length of main body 14, or only a small portion of the length of main body 14, including approximately one eight, one quarter, one third, three eights, one half, five eights, two thirds, three quarters, seven eights, or the like or any other amount or portion of main body 14.

In one arrangement, as one example, a stop member 32 is positioned at the forward end of receiving member 28. Stop member 32 is formed of any suitable size, shape and design and is configured to engage the forward side of light member 42 when light member 42 is inserted within receiving member 28 and serves to stop light member 42 from passing through the opening 30 of receiving member 28. In this way, stop member 32 serves to retain light member 42 within receiving member 28.

In one arrangement, as one example, as is shown, the sides of slot 30, that is opposing ends 74 and sidewalls 76, extend in an approximately straight manner between front side 16 and back side 18. That is, the sides of slot 30 extend in approximate perpendicular alignment to the front side 16 and back side 18 of main body 14. In this arrangement, stop member 32 forms a lip that extends inward into the opening 30 of receiving member 28 adjacent the forward end of this opening 30. In the arrangement shown, stop member 32 is a lip that extends continuously, or in a generally continuously manner, around the opening 30 of receiving member 28, however in other arrangements stop member 32 may be formed of one or more protrusions, fingers, flanges, lips or any other feature that narrows the opening of receiving member 28 thereby preventing light member 42 from passing through receiving member. By placing stop member 32 at the forward end of the opening this maximizes the depth of the opening of receiving member 28.

In one arrangement, as one example, a plurality of fingers 34 are positioned at the rearward end of receiving member 28. Fingers 34 are formed of any suitable size, shape and design and are configured to engage the rearward side of light member 42 when light member 42 is inserted within receiving member 28 and serves to frictionally engage and hold light member 42 when light member 42 is within receiving member 28 and prevent light member 42 from coming out of receiving member 28 once inserted therein. In this way, fingers 34 serve to retain light member 42 within receiving member 28.

In one arrangement, as one example, as is shown, the sides of slot 30, that is opposing ends 74 and sidewalls 76, extend in an approximately straight manner between front side 16 and back side 18. That is, the sides of slot 30 extend in approximate perpendicular alignment to the front side 16 and back side 18 of main body 14. In this arrangement, fingers 34 form a plurality of protrusions that extend inward into the opening of receiving member 28 adjacent the rearward end of this opening. In the arrangement shown, fingers 34 are formed of two pairs of inwardly extending protrusions, wherein one protrusion of each pair of these protrusions are positioned on each, opposing, side of the opening of receiving member 28. In the arrangement shown, as one example, one pair of fingers 34 are positioned near each end 74 of receiving member 28 and as such, each end of light member 42 is anchored in receiving member 28 by fingers 34.

In the arrangement shown, stop member 32 forms a continuous lip that extends all the way around the forward side of the opening of receiving member 28, whereas in contrast fingers 34 only cover a portion of the rearward side of the opening of receiving member 28. By only covering a portion of the rearward side of the opening of receiving member 28, fingers 34 allow insertion of light member 42 into receiving member 28 with a desirable (and not excessive) amount of force. This arrangement also allows for the removal of light member 42 from receiving member 28 with a desirable (and not excessive) amount of force. This arrangement also allows fingers 34 to hold light member 42 within receiving member 28 with a desirable amount of force, while being adequately secure and not, ever, coming out unintentionally during use.

While four fingers 34 are shown in use, any number of fingers 34 are hereby contemplated for use such as one, two, three, four, five, six, seven, eight, nine, ten, eleven, twelve or more, as is the use of a single, continuous, finger, similar to the lip of stop member 32. Care is taken to ensure that the dimensions of stop member 32 and fingers 34 correspond with that of light member 42 such that light member 42 is inserted within, held within and removed from receiving member 28 with a desirable amount of force.

In the arrangement shown, as one example, the main body 14 of lure 12 is a relatively thin member when viewed from the left side 24 or the right side 26. To increase the depth of the opening of receiving member 28 a collar 36 extends rearward a distance from back side 18. In the arrangement shown, as one example, collar 36 extends around the opening 30 of receiving member 28 in a continuous manner, or a generally continuous manner, and extends rearward from back side 18 a distance. When viewed from back side 18, collar 36 forms a relatively thin lip. Fingers 34 are connected to the rearward end of collar 36 and extend inward therefrom. In this way, collar 36 increases the depth of the opening of receiving member 28 without increasing the thickness of the entire main body 14. Said another way, use of collar 36 allows for increasing the depth of the opening of receiving member between stop member 32, at the forward side of the opening of receiving member 28, and fingers 34, at the rearward side of the opening of receiving member 28, without the need to increase the forward-to-back thickness of the entire main body 14. This allows the main body 14 to be formed of minimal material and of minimal weight, which is important in some applications, such as ice fishing.

While in the arrangement shown, opening 30 is shown as a slot, opening 30 may be formed of any other shape. As one example, opening 30 may be a formed of a one or more circular openings in the front side 16 of main body 14 that align with the light member 42. As another example, opening 30 is only open to the back side 18 of main body 14 and has no openings to the front side 16 of main body 14. As another example, opening 30 may have one or more extensions of material that extend across it extending from sidewall 76 to sidewall 76.

In an alternative arrangement, light member 42 is inserted into receiving member 28 through opening 30 which is placed in the edge of main body 14 either or both at the top side 20 and/or bottom side 22. In this arrangement, opening 30 is more like a cylindrical bore that extends through the main body 14 that imparts sufficient enough friction upon light member 42 that when light member 42 is inserted within this opening 30 that light member 42 is frictionally held in place during use. In this arrangement, additional openings in the front side 16 and back side 18 of main body connect to opening 30 thereby letting light generated by light member 42 to shine outward from main body 14. These openings may be a single or multiple cylindrical openings, a single slot, a slot with a plurality of extensions of material that extend across the slot, or any other configuration.

Feature: In one arrangement, main body 14 includes a feature 38. Feature 38 is formed of any suitable size, shape and design and serves to add structural interest and contours to the main body 14. In one arrangement, as one example, feature 38, when viewed from the bottom side 22 of main body 14 forms a curved shape or a partial portion of a cylindrical shape in the lower end of main body 14 that recesses into the back side 18 of main body 14 and protrudes out of the front side 16 of main body 14, however any other shape, as well as location, is hereby contemplated for use. In addition, while one feature 38 is shown in use in main body 14, any number of features 38 are hereby contemplated for use such as two, three, four, five, six, seven, eight, nine, ten or more.

In the arrangement shown, as one example, where feature 38 is formed as a curved shape or a part of a cylindrical shape, the center axis of feature 38 is aligned to extend in parallel with and centered upon the length of main body 14 between top side 20 and bottom side 22, however any other alignment or arrangement is hereby contemplated for use. Also, as is shown, when viewed from left side 24 or right side 26, feature 38 extends at an angle to main body 14. That is, in the arrangement shown, as one example, the depth of feature 38 increases as the feature extends from its upper end to its lower end. Meaning that the depth of recess (on back side 18) and the depth of protrusion (on front side 16) of feature 38 is greatest at the lower end of feature 38; and in contrast, than the depth of recess (on back side 18) and the depth of protrusion (on front side 16) of feature 38 is the smallest at the lower end of feature 38.

In the arrangement shown, as one example, the shape and curvature of feature 38, along with the curve of main body 14 and the other features of main body, cause lure 12 to have desirable action during use. As an example, when lure 12 is pulled through water, it wobbles or oscillates through the water. As another example, when lure 12 is dropped within a column of water, it flutters. As such, these features cause desirable action during use that attract fish and entice them to strike.

Openings & Rings: Main body 14 includes an opening 40 positioned at the upper end and at the lower end of main body 14. Openings 40 are formed of any suitable size, shape and design and are configured to connect to main body 14 to other components. In one arrangement, as one example, openings 40 are generally circular openings that extend through main body 14 from front side 16 to back side 18, however any other shape is hereby contemplated for use. These openings 40 are generally centrally positioned within the main body 14 between left side 24 and right side 26.

In one arrangement, as is shown, a ring 70 is connected to the upper opening 40. This ring 40 is generally used to connect to fishing line.

In one arrangement, as is shown, a ring 70 is connected to the lower opening 40. This ring 40 is generally used to connect to hook 72, either directly or by connection to an intermediary or secondary ring 40, as is shown.

Rings 40 may be formed of any suitable size, shape and design. In one arrangement, as is shown, rings 40 are what are known as key rings or split rings and are formed of overlapping layers of wire that form a circular shape.

Hook: In one arrangement a hook 72 is connected to the lower opening 40 by one or more rings 70. Hook 72 is formed of any suitable size, shape and is configured to hook a fish. In the arrangement shown, as one example, hook 72 is a treble hook that includes three shanks and barbs that share a common shaft that connects to a ring 40. Any other form of a hook 72 is hereby contemplated for use such as a single hook, a double hook, a quad hook, multiple single, double or treble hooks or any other form of a hook or hooks. In another arrangement, as is shown, hook 72 is connected to the bottom side 22 directly.

### Light Member

Lure 12 is configured to receive a light member 42 within receiving member 28. Light member 42 is formed of any suitable size, shape and design and is configured to glow as well as be connected to main body 14 of lure 12. In the arrangement shown, as one example, light member 28 includes a main body 44 having a sidewall 46 that is formed in a generally cylindrical shape. The cylindrical sidewall 46 extends a length and terminates in ends 48 that are generally rounded and form a partial portion of a sphere at each end of the main body 44. However any other shape for light member 42 is hereby contemplated for use.

In the arrangement shown, light member 42 is sized and shaped to fit within and be held by receiving member 28 of main body 14. That is, light member 42 is sized and shaped and configured such that it may be forced within the opening of receiving member 28 when enough pressure is applied that the light member 42 flexes or deforms enough to allow insertion of light member 42 within receiving member 28. Similarly, light member 42 is sized and shaped and configured such that it may be forced out of the opening of receiving member 28 when enough pressure is applied that the light member 42 flexes or deforms enough to allow removal of light member 42 within receiving member 28.

In one arrangement, light member 42 is formed of a miniaturized version of what is known as a glow stick. That is, light member 42 is a self-contained, short-term light-source that consists of a translucent plastic tube containing isolated substances that, when combined, generate light through what is known as chemiluminescence. Through this chemiluminescence light member 42 does not require an external energy source. However any other form of a light generating member is hereby contemplated for use as light member 42 including battery powered lights, LEDs or any other light generating device or configuration.

### Removal Tool

System 10 includes a removal tool 50. Removal tool 50 is formed of any suitable size, shape and design and is configured to remove a light member 42 from receiving member 28 when light member 42 is held within receiving member 28. In the arrangement shown, as one example, removal tool 50 includes a main body 52. Main body 52 is formed of any suitable size, shape and design and is configured to allow a user to grasp the removal tool 50 and apply pressure to the removal tool 50 sufficient enough to remove the light member 42 from the receiving member 28 of lure 12.

In one arrangement, as one example, main body 52 is a generally circular member having a generally flat and planar top side 54 and a generally flat and planar bottom side 56 that form planes that extend in approximate parallel spaced relation to one another. The top side 54 and bottom side 56 terminate in an outward edge that is generally circular in shape. However, any other size, shape and design is hereby contemplated for use.

In one arrangement, as one example, a fin 58 is connected to and extends downward from the bottom side 56 of main body 52. Fin 58 is formed of any suitable size, shape and design and is configured to fit within the slot 30 of receiving member 28 of main body 14 of lure 12 thereby forcing an inserted light member 42 out of the receiving member 28.

In one arrangement, as one example, fin 58 is a generally planar member that extends out of the bottom side 56 of main body 52 in a generally perpendicular and planar fashion. That is, the fin 58 is positioned in generally perpendicular planar fashion to the plane that forms the bottom side 56 (and top side 54) of main body 52. In one arrangement, as is shown, fin 58 extends a lateral length between opposing end walls 78 that connect opposing planar sidewalls 80. Fin 58 terminates at its lower edge 82. The length between opposing end walls 78 is approximately equivalent to or less than the length of slot 30 such that fin 58 may fit within slot 30. Similarly, the distance between opposing sidewalls 80 of fin 58 is approximately equivalent to or less than the width of slot 30 such that fin 58 may fit within slot 30.

In one arrangement, when viewed from the side, the lower edge 82 of fin 58 extends at an angle to the planes formed by the top side 54 and bottom side 56 of removal tool 50. As such, one of the opposing end walls 78 is longer than the other end wall 78.

In one arrangement, as is shown, removal tool 50 includes a connecting member 84. Connecting member 84 is formed of any suitable size, shape and design and is configured to facilitate connecting of removal tool 50 to another object, such as a string, keychain, a necklace, a retaining member, or any other object or the like. In one arrangement, as one example, connecting member 84 is formed of a protrusion that extends outward from the edge of main body 52 in a semi-circular manner and includes an opening 86 therein. In one arrangement, opening 86 is configured to receive a string or fishing line there through.

### Connector

System 10 includes a connector 60. Connector 60 is configured to connect to and hold a light member 42 therein as well as facilitate connection to another object such as a hook, jig, bobber or any other member. Connector 60 is formed of any suitable size, shape and design. In the arrangement shown, as one example, connector 60 includes a main body 62. Main body 62 is formed of any suitable size, shape and design and is configured to receive and hold light member 42 therein so that light member 42 may be connected to other objects.

In one arrangement, as one example, main body 62 is a generally cylindrical member having a generally cylindrical opening 64 that extends through its approximate middle. Opening 64 is sized and shaped to receive light member 42 therein with close, tight tolerances and frictional engagement. In one arrangement, connector 60 is formed of a flexible material that stretches to receive light member 42 within opening 64, such as a flexible plastic, silicon, rubber or any other plastic or composite material.

In one arrangement, as one example, an arm 66 is connected to and extends outward from main body 52 in a generally perpendicular manner to the center axis of opening 64. Arm 66 is formed of any suitable size, shape and design and is configured to connect main body 62 and an attached light member 42 to another object such as a hook, jig, bobber or any other member. Like main body 62, arm 66 includes a generally cylindrical opening 68 that extends in an approximately perpendicular manner to the length of arm 66 and through arm 66 adjacent its outward end. In the arrangement shown, as one example, arm 66 is substantially narrower than main body 64, however in other arrangements, main body 62 and arm 66 may be the same width. In one arrangement, as one example, the center axis of openings 64 and opening 68 extend in approximate parallel spaced relation to one another. As an example, in this arrangement, when the shank of a hook is inserted through the opening 68 in arm 66 the length of light member 42 held within the opening 64 in main body 62 extends in approximate parallel spaced alignment to the length of the shank of the hook to which connector 60 is connected.

### In Operation

Assembly/Insertion: The glow in the dark fishing lure system 10 is used by selecting the desired lure 12, which may be configured in countless sizes and shapes and configurations and colors and patterns, and the desired light member 42, which may also be configured in several colors and luminosities. Once light member 42 is selected, the light member 42 is activated by bending the light member 42 until the container within the light member 42 is broken thereby releasing its contents to mix with the other contents held within the light member 42 which causes chemiluminescence. To improve mixing of the components the light member 42 is shaken.

Once activated the light member 42 is inserted within the receiving member 28 of lure 12. This is accomplished by aligning the light member 42 with the slot 30 in the back side 18 of main body 14. More specifically the ends 48 of light member 42 are positioned in alignment with or just inside the ends 74 of slot 30, and the sidewall 46 of light member 42 is positioned in alignment with or just inside the sidewalls 76 of slot 30. Once light member 42 is properly aligned, pressure is applied on the light member 42 forcing it toward the main body 14 of lure 12.

As pressure is applied to the light member 42 the sidewall 46 of light member 42 engages the rearward edge of collar 36 and/or fingers 34. As sidewall 46 of light member 42 engages the rearward edge of collar 36 and/or fingers 34 light member 42 slightly deforms as pressure is applied thereby allowing light member 42 to squeeze between opposing fingers 34 and the opposing sides 76 and ends 74 of receiving member 28.

Once light member 42 passes fingers 34, light member 42 is held within receiving member between the inward edges of fingers 34, opposing sides 76 and ends 74 of receiving member 28. Once light member 42 passes fingers 34, which define the narrowest part of the back side of receiving member 28, light member 42 at least partially goes back to its pre-deformed shape.

When light member 42 is fully inserted within receiving member 28: the ends 48 of light member 42 are positioned just inside of and/or in frictional engagement with the ends 74 of slot 30; the sides of light member 42 are positioned just inside of and/or in frictional engagement with the sidewalls 76 of slot 30; the forward side of light member is positioned just inside edge of and/or in frictional engagement with the interior edge of stop member 32 of slot 30; the rearward side of light member is positioned just inside of and/or in frictional engagement with the interior edge of fingers 34 of slot 30. In this arrangement, light member 42 is captured within receiving member 28.

Use: During use, when light member 42 is inserted within receiving member 28, light emitted from light member 42 is visible from the slot 30 in the front side 16 of main body 14 as well as from the slot 30 in the rear side 18 of main body 14. In this assembled state, the lure 12 may be cast, trolled, jigged or used in any manner without fear that the light member 42 will become unintentionally dislodged. This is due to the close and tight tolerances and frictional engagement between light member 42 and receiving member 28.

Disassembly/Removal: When the light member 42 has expired or a change is needed, the light member 42 is quickly and easily removed from within the receiving member 28 of lure 12. This is accomplished by grasping the removal tool 50 and aligning the fin 58 of removal tool 50 with the slot 30 in the front side 16 of main body 14. More specifically the end walls 78 of fin 58 are positioned in alignment with or just inside the ends 74 of slot 30, and the sidewall 80 of fin 58 is positioned in alignment with or just inside the sidewalls 76 of slot 30. Once fin 58 is properly aligned, pressure is applied on the top side 54 of the removal tool 50 thereby forcing it toward the main body 14 of lure 12.

As pressure is applied to the removal tool the sidewall 46 of light member 42 engages the interior edges of fingers 34. As sidewall 46 of light member 42 engages the fingers 34 light member 42 slightly deforms as pressure is applied thereby allowing light member 42 to squeeze between opposing fingers 34.

Once light member 42 passes fingers 34, light member 42 is free from the receiving member and the light member 42 can be discarded. A new light member 42 can then be inserted in the manner described herein.

Decorative Patterns: In one arrangement, as is shown, the front side 16, back side 18, edges or any other surface of lure 12 includes a decorative pattern. This decorative pattern may be formed of any suitable size, shape and design and is configured to provide an appealing aesthetic appearance as well as attract fish and entice fish to strike. This decorative pattern may be painted on, sprayed on, printed on, applied as a wrap, or applied by any manner, method or means.

Glow In The Dark Coatings: In one arrangement, in addition to the glowing light of light member 42, lure 12 may also include a glow in the dark coating, such as glow in the dark paint. Glow in the dark paint may be formed of any suitable size, shape and design and is configured to provide an aesthetic glow that provides an appealing aesthetic appearance as well as attract fish and entice fish to strike. This glow in the dark paint may be painted on, sprayed on, printed on, applied as a wrap, or applied by any manner, method or means. In arrangement, this glow in the dark paint may be formed of a phosphorescent material that absorbs light energy but does not immediately re-emit the radiation it absorbs. Instead this phosphorescent material releases this energy over a period of time as a glow.

Textured Surfaces: In one arrangement, the front side 16 and/or back side 18 of main body 14 are generally smooth. In another arrangement, the front side 16 and/or back side 18 of main body 14 include a textured pattern that covers a portion of the surface or the entire surface. This textured surface may be formed of any suitable size, shape and design and is configured to provide an appealing aesthetic appearance as well as attract fish and entice fish to strike. In one arrangement, this texture surface may be used in association with a shiny or glimmering surface, such as silver, chrome, gold or other metallic polish or coating that enhances the effect of the texturing.

Recess & Eye: In one arrangement, as is shown, the front side 16 of lure 12 includes a recess 88 that receives an eye 90 therein. This recess 88 and associated eye 90 may be formed of any suitable size, shape and design and is configured to provide an appealing aesthetic appearance as well as attract fish and entice fish to strike. This recess 88 and eye 90 provide depth and interest to lure 12 that improve its appearance and/or effectiveness.

Multiple Slots-Multiple Colors: In the arrangement shown, as one example, lure 12 is shown in association with a single receiving member 28 that receives a single light member 42. This means that the user must select which color light member 42 to use. In another arrangement, lure 12 includes two, three, four, five, six, seven, eight, nine, ten or more receiving members 28 therein where each receiving member may receive a light member 42 therein. This allows a user to select more than one color of light members 42 to use at a single time with lure 12, which in some instances may improve the effectiveness of lure 12. The use of multiple light members 42 also increases the brightness of the lure 12 which may make it more-visible and more effective in some conditions, such as muddy water.

### Alternative Arrangements

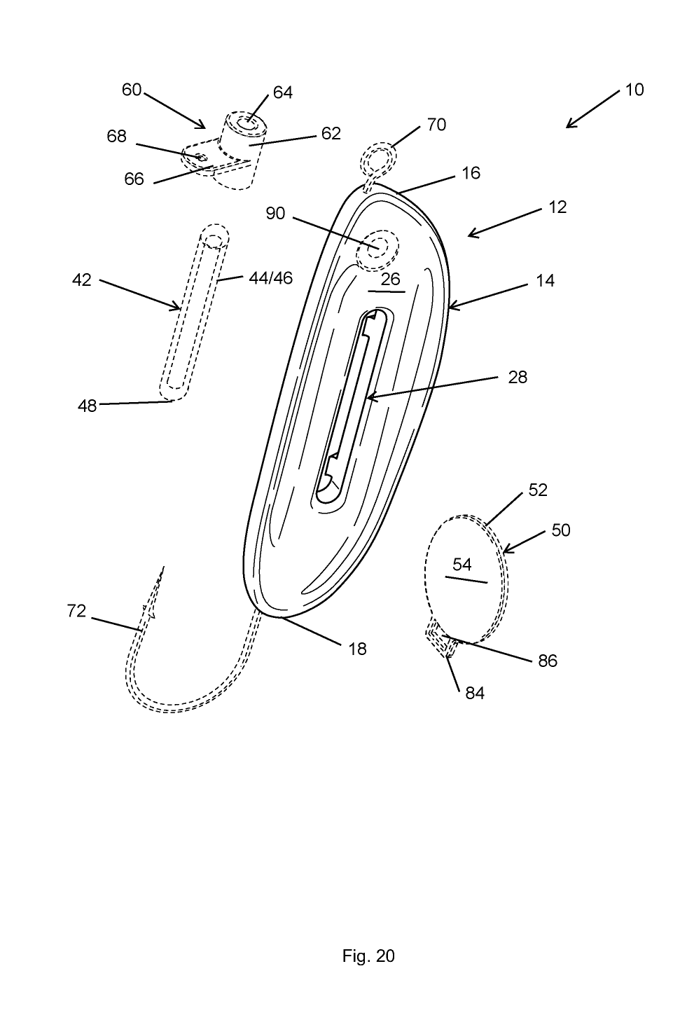

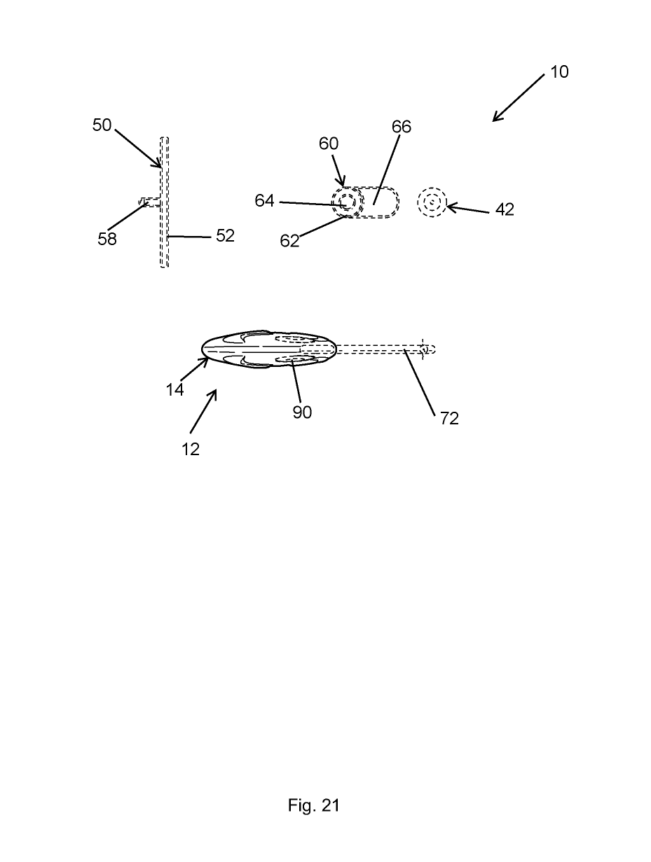

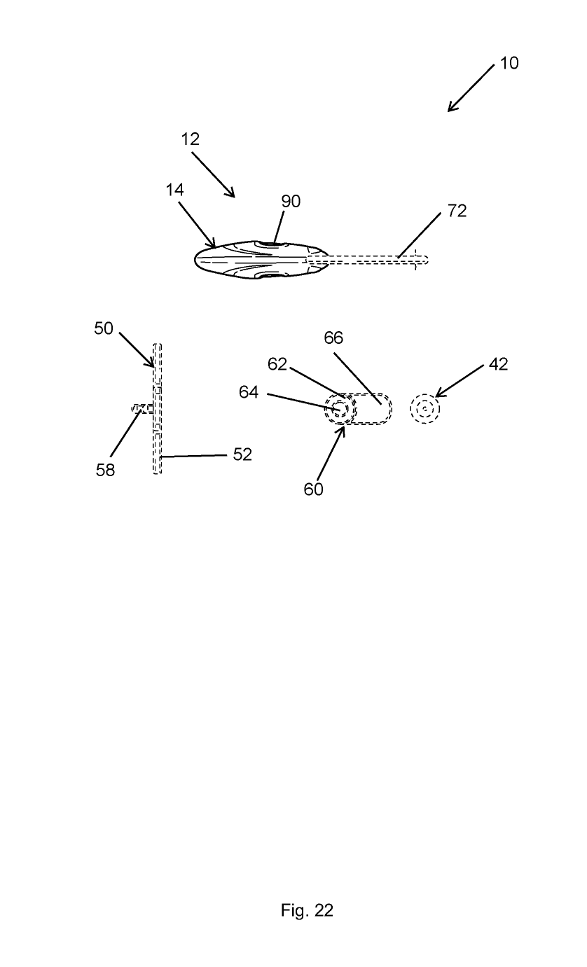

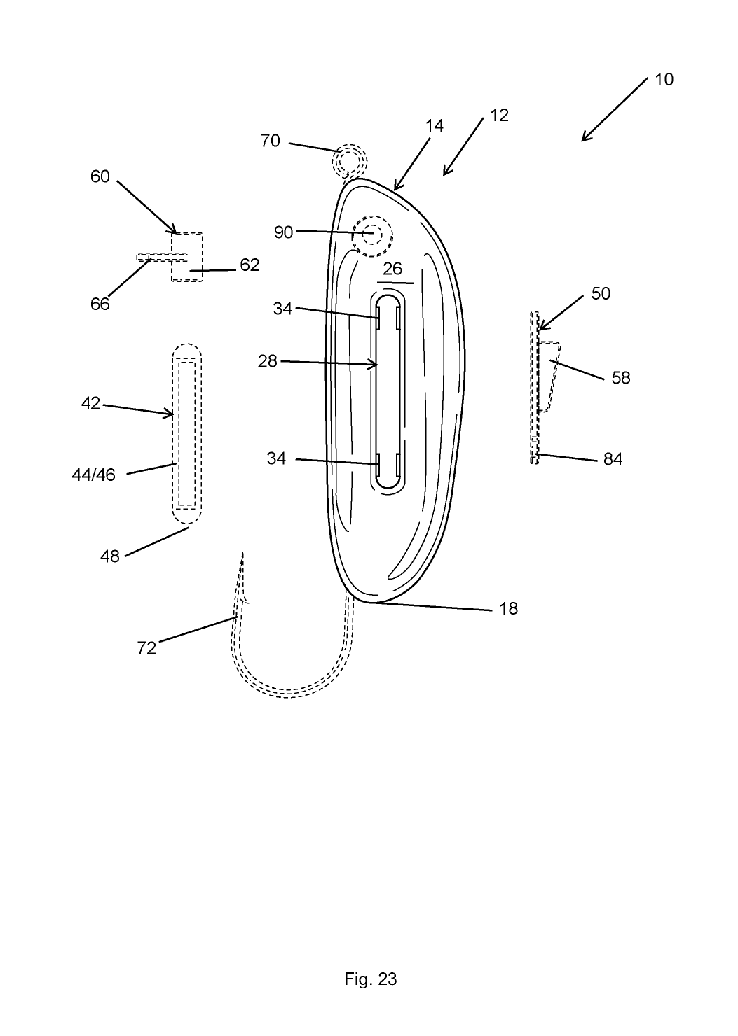

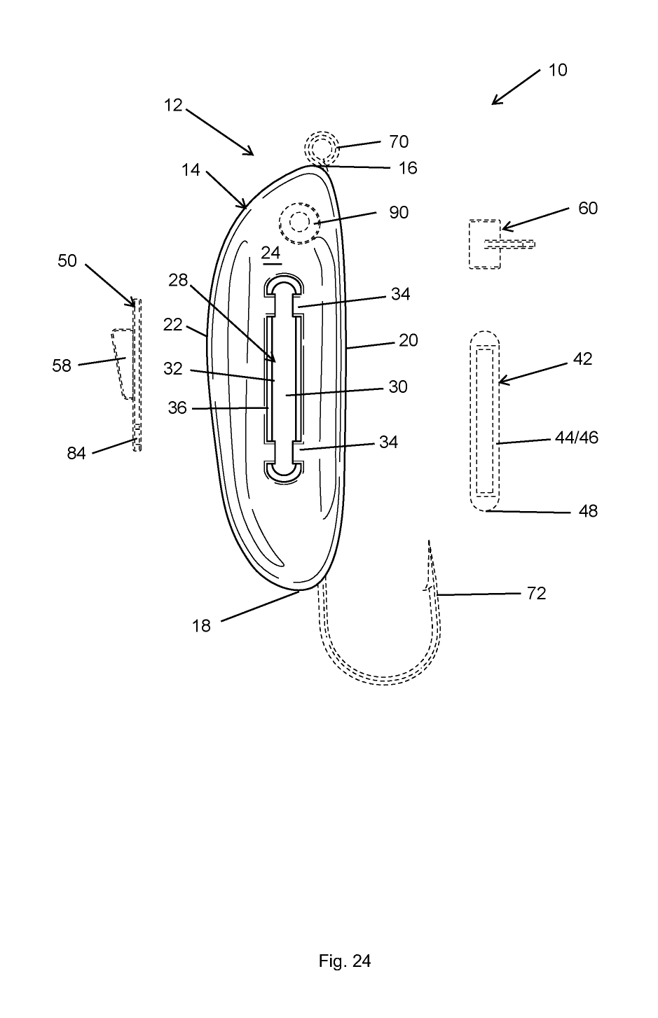

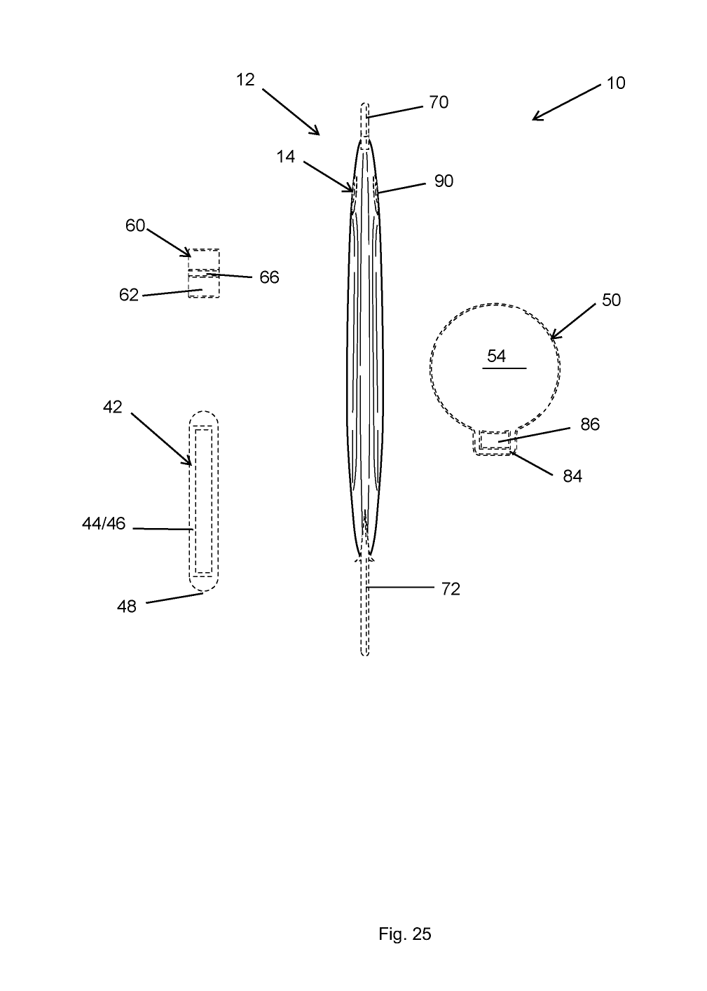

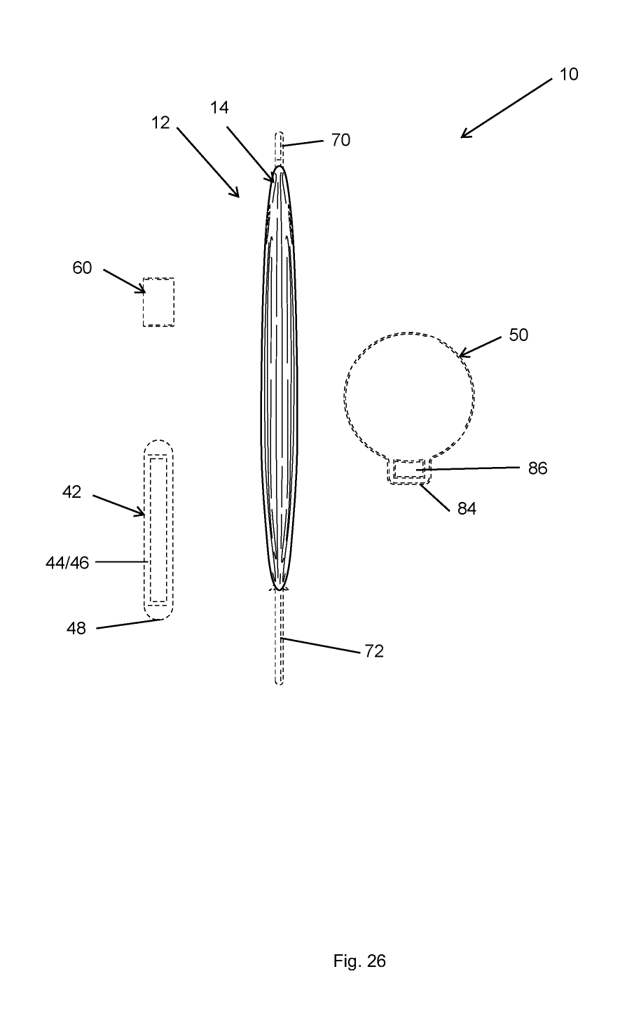

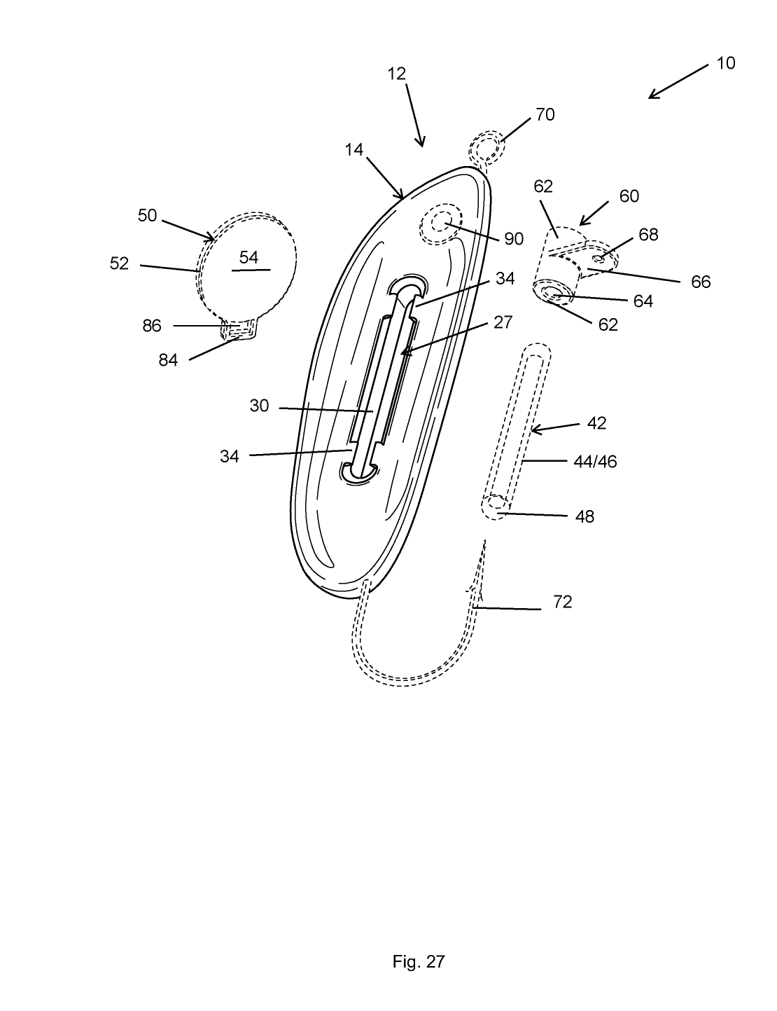

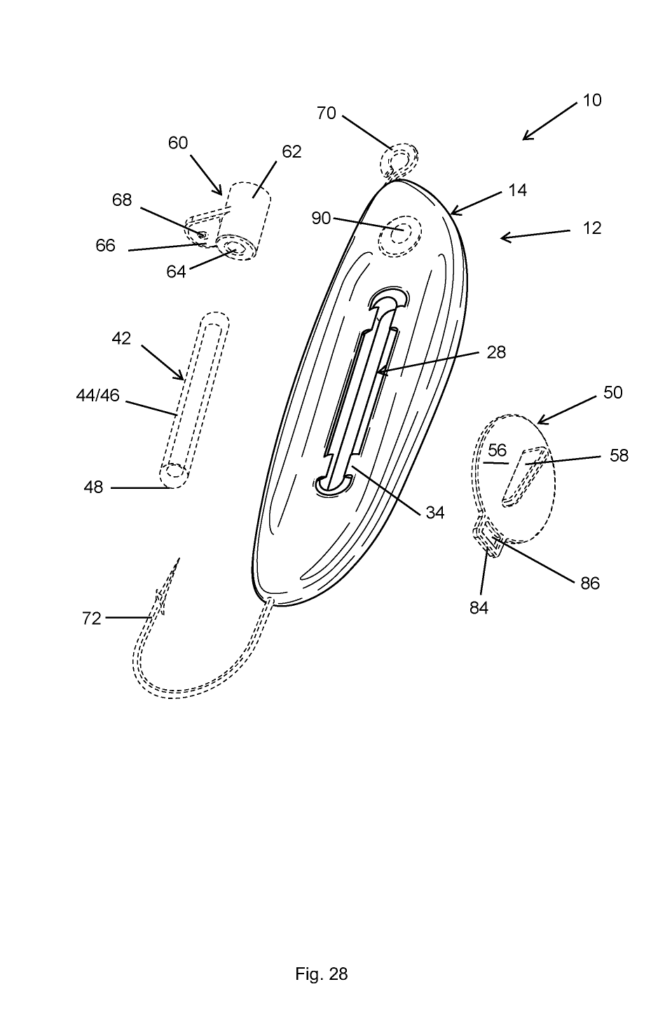

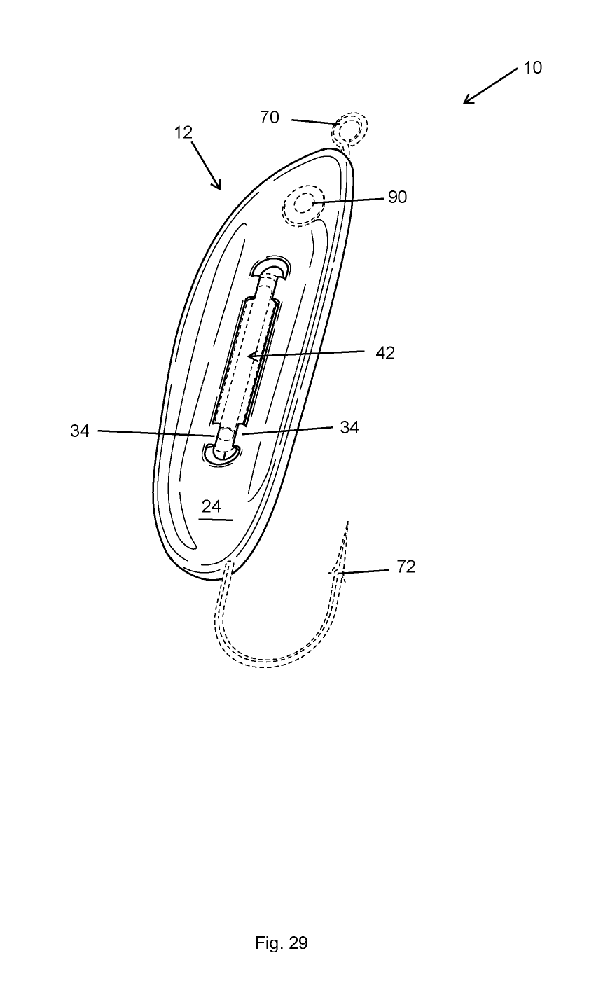

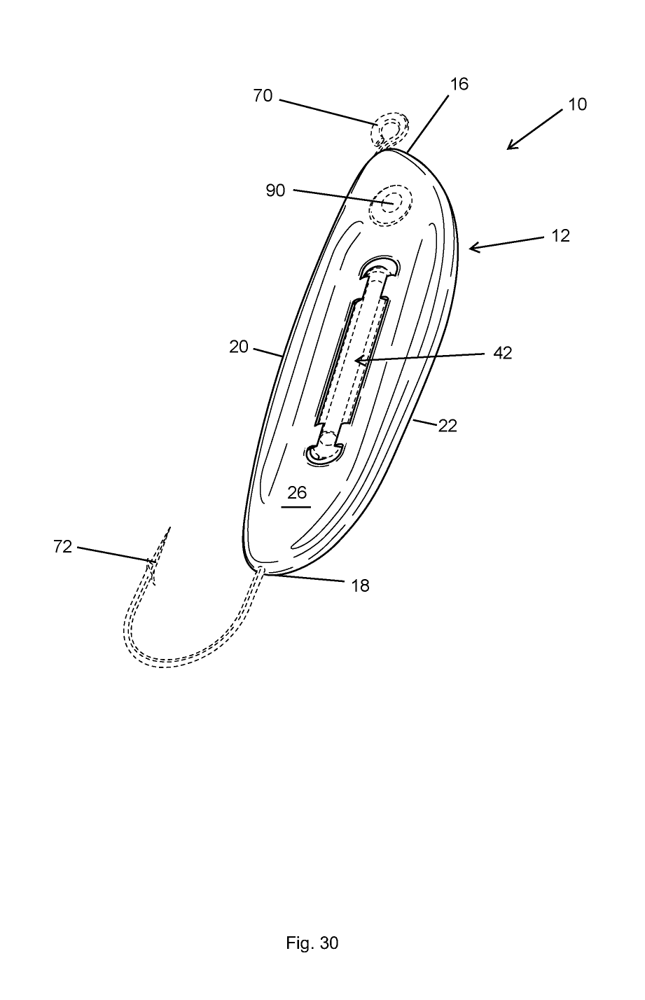

In the arrangement shown herein lure 12 is shown as what is known in the fishing arts as a spoon. In another arrangement, as shown in FIGS. 20-30, lure 12 is shown as what is known in the fishing arts as a jig. However, the disclosure herein is not so limited. In contrast, the disclosure wherein a removable light member 42 is used in association with a lure 12 is hereby contemplated for use with any form or a lure 12. In addition, it is hereby contemplated that any number of removable light members 42 may be part of a lure 12, such as two, three, four or more, which may be of the same color (white, green, yellow, chartreuse, pink, purple, blue, orange, red, or any other color). That is, main body 14 of lure 12 may be formed of any shape. Main body 14 of lure 12 may be formed of a single member or a plurality of connected members. Lure 12 and main body 14 may be a jig, a crank bait, a spinner bait, a top-water bait, a mid-water bait, casting bait, a trolling bait, a jigging bait, or any other size, shape and design.

In one arrangement, lure 12 is formed of what is known as a jig. Jigs are known as lures 12 having a weighted head or body which serves as main body 14 with a fixed or rigid hook or hooks 72, although hook 72 can be connected by any other manner such as an intermediary ring or rings 70. In this arrangement, the main body 14 of the jig includes the one or more receiving members 28 that receive a light member 42 therein. The receiving member 28 has at least one opening or slot 30, which may be formed of any shape, operatively connected thereto that allows light from a light member 42 held within the receiving member 28 to pass outward through the main body 14 to attract fish. In one arrangement, the receiving member 28 of the jig includes a slot 30 that extends through the main body 14 of the jig. In this arrangement, when the light member 42 is inserted into the receiving member 42 of the main body 14 light is visible from outside of the main body through slot 30.

In another arrangement, the receiving member 28 of the jig does not have a slot 30 that extends through the main body 14 of the jig. In this arrangement, the receiving member 42 is not connected to a slot 30. In this arrangement, the light member 42 is inserted into the receiving member 42 from one side of the lure 12 and the light is primarily visible on the side of the lure 12 from which it is inserted (such as the front side 15, back side 18, top side 20, bottom side 22, left side 24 and/or right side 26), but the light does not extend through a slot 30 connected to receiving member 42. In this arrangement, light from light member 42 is visible from the main body 14 of the lure 12 on the side or sides of the lure 12 that light member 42 is inserted into receiving member 28. Any other form of a lure 12 is hereby contemplated for use.

In this arrangement, the jig may take the form of a head having eyes, a head and a body, or alternatively the jig may take on the form of a fish, a bug, a nymph, a worm, or any other creature, or any other object.

In one arrangement, when light member 42 is held within main body 14, regardless of the form of main body 14, a slot 30 is connected on opposing sides of light member 42, such as front side 16 and back side 18, or left side 24 and right side 26, or top side 20 and bottom side 22, or any combination thereof, or the like. In this arrangement, light from light member 42 is visible on opposing sides of lure 12 through slots 30.

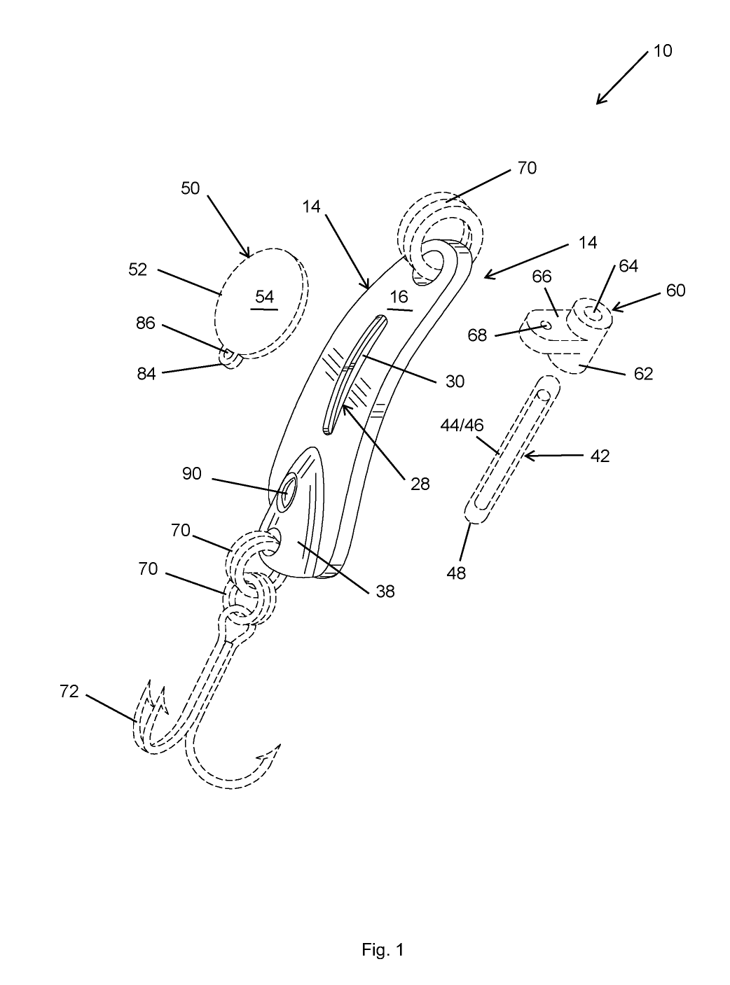

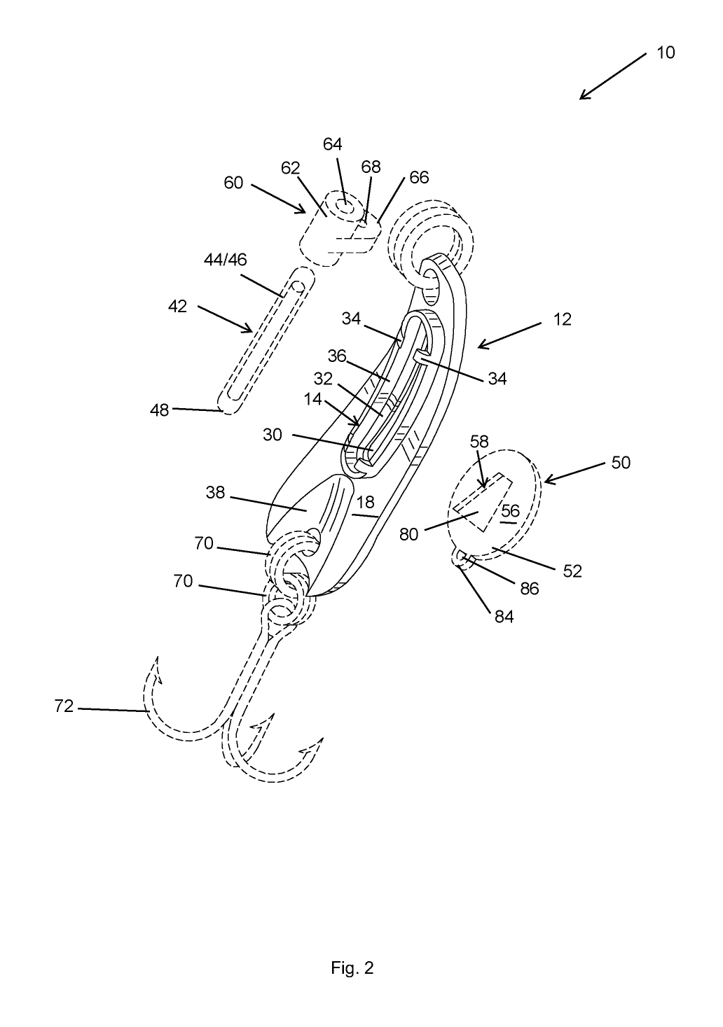

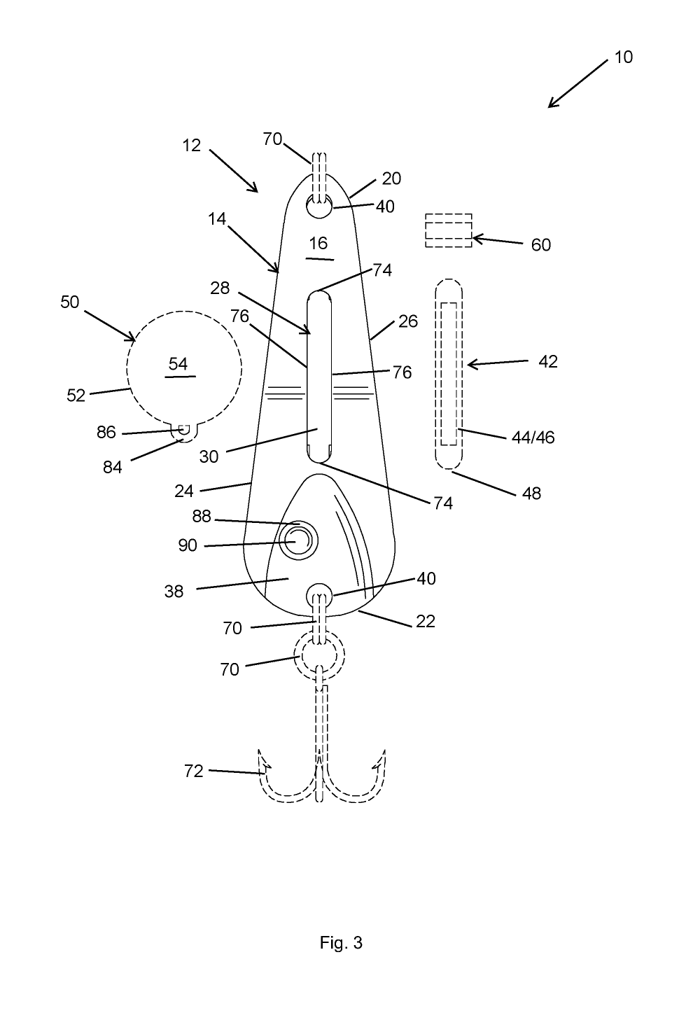

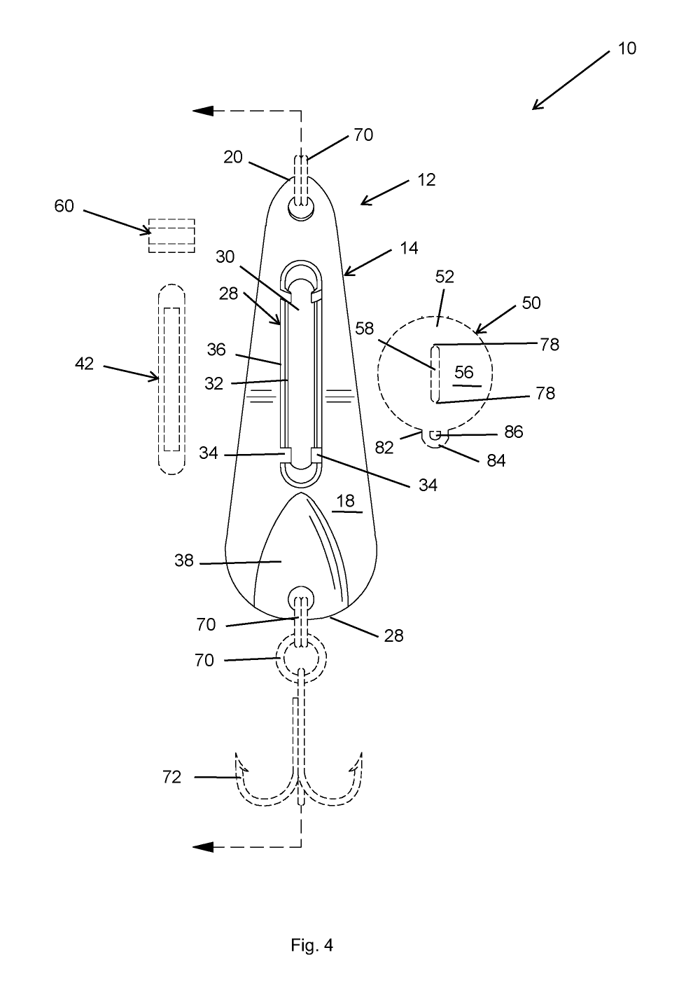

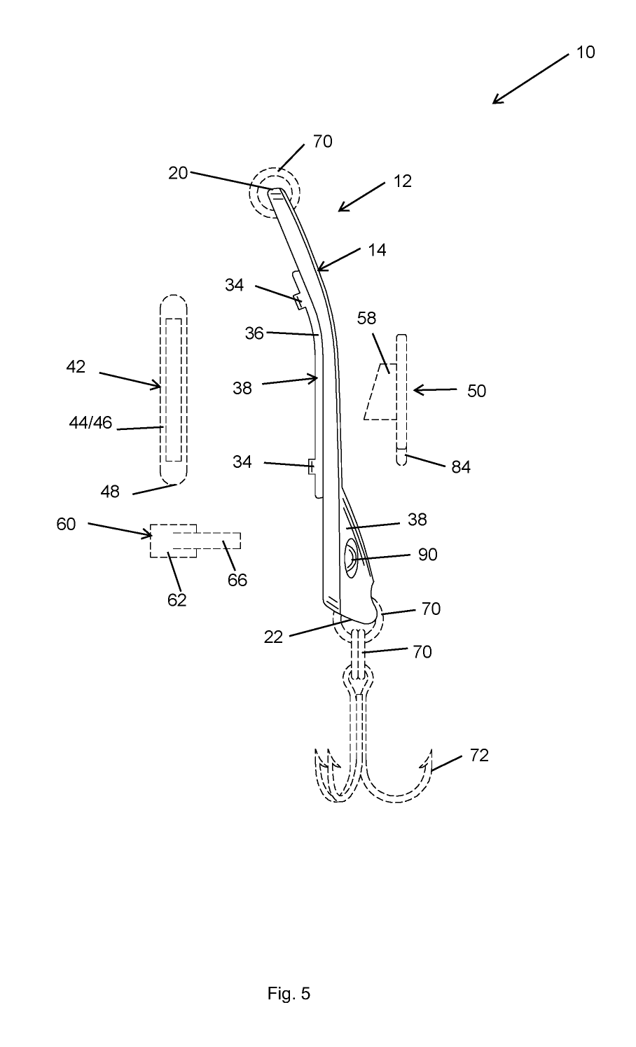

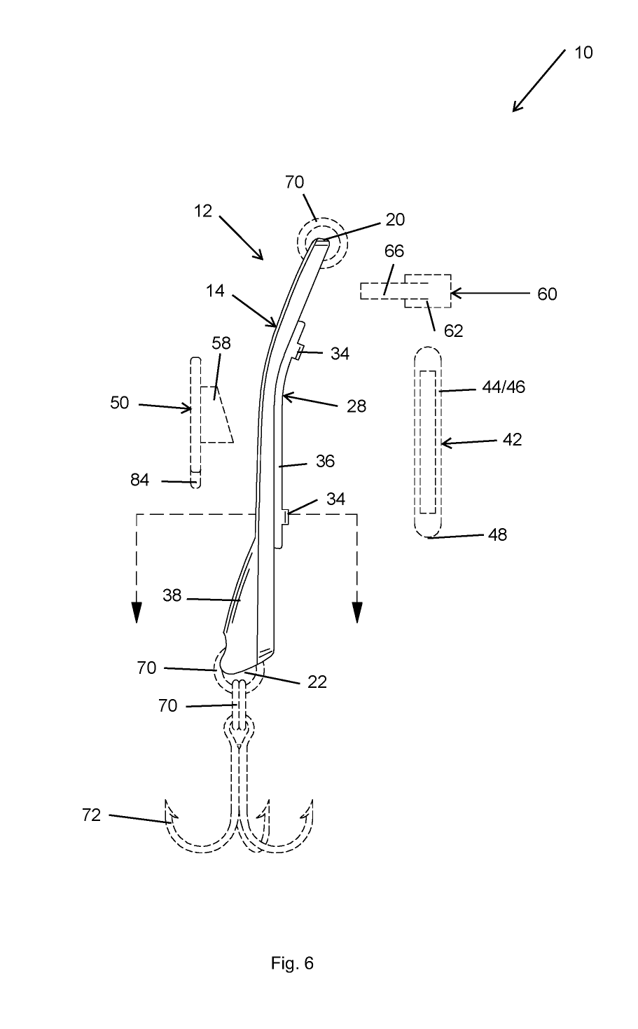

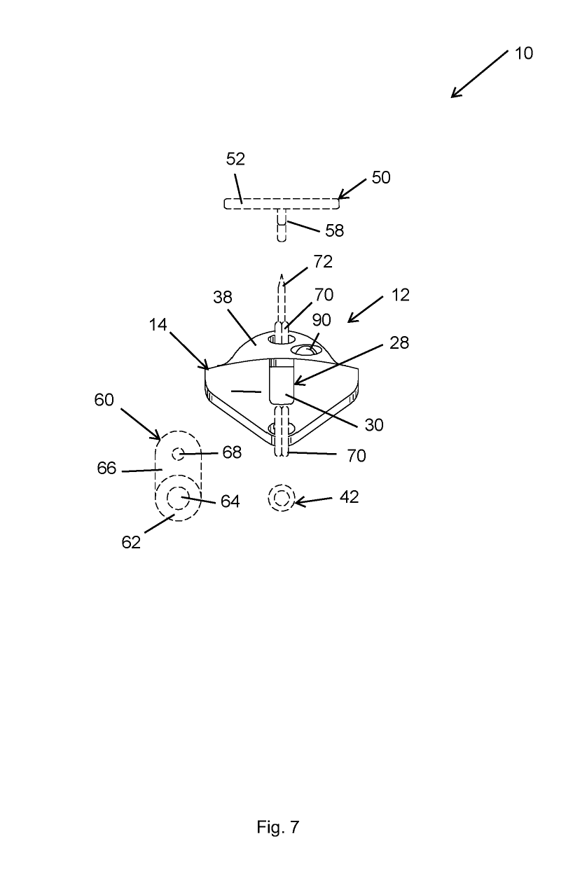

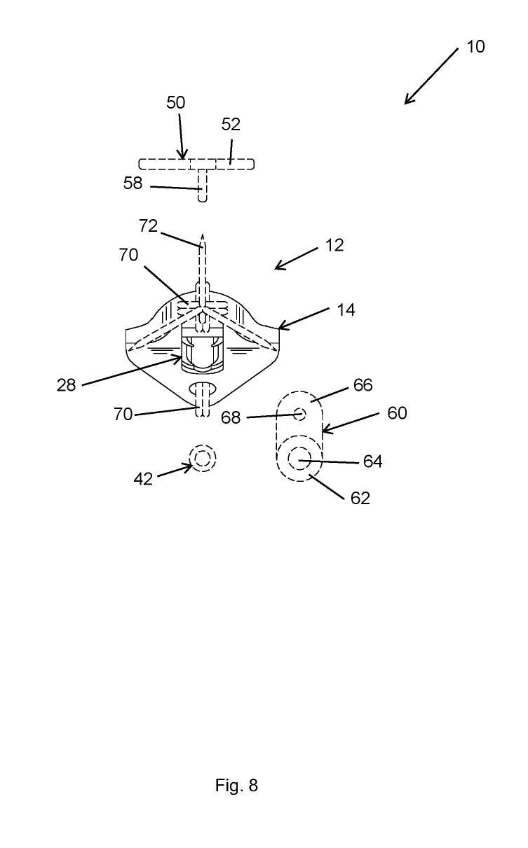

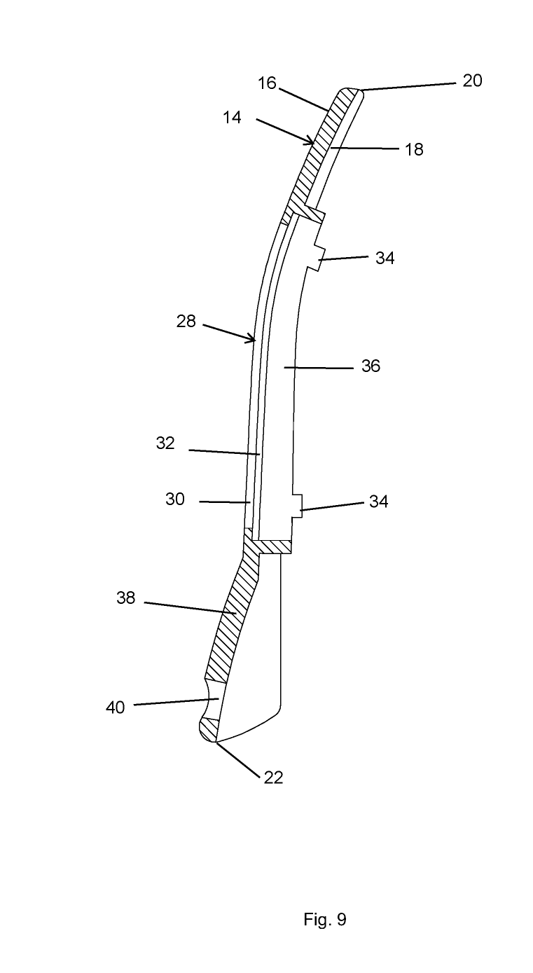

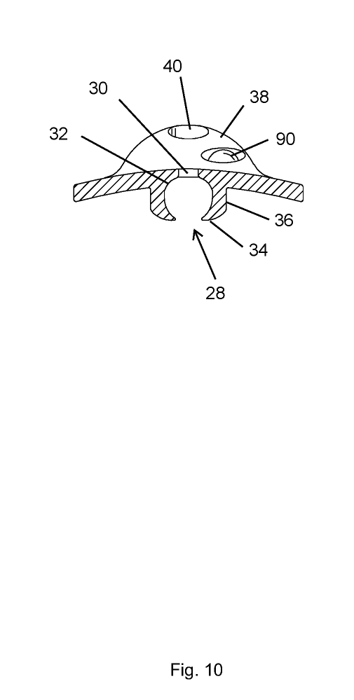

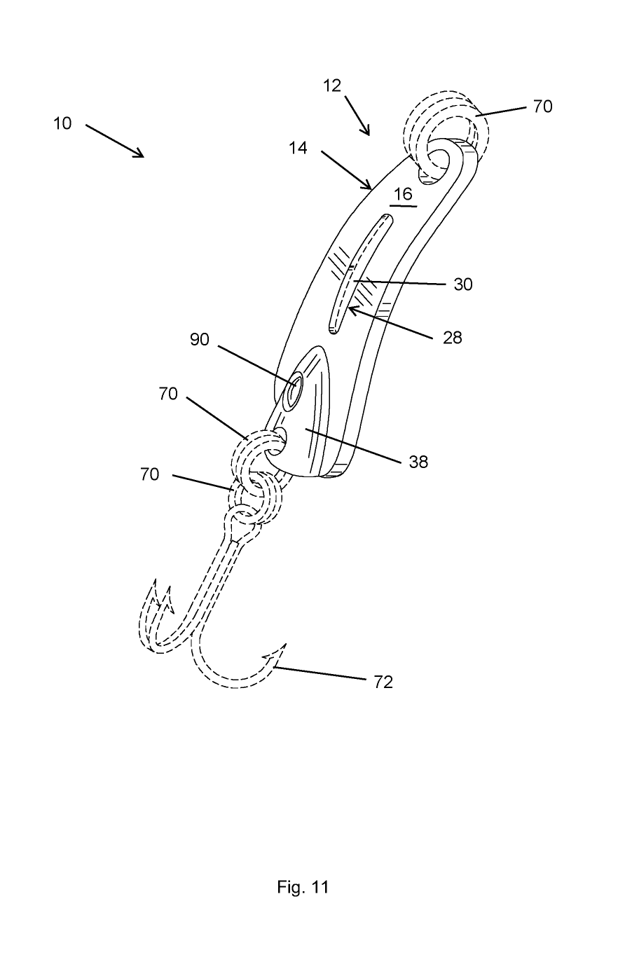

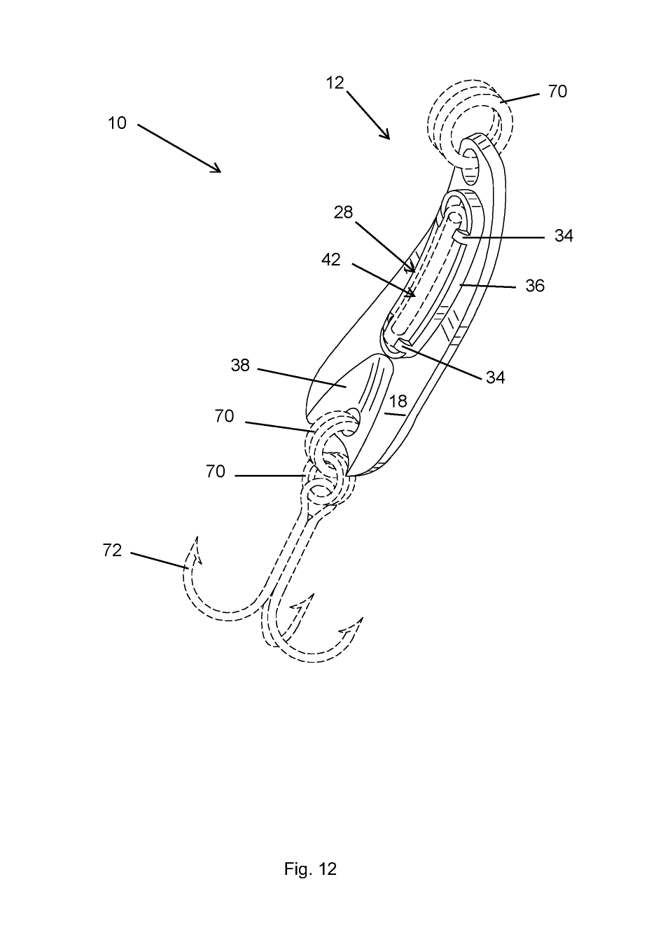

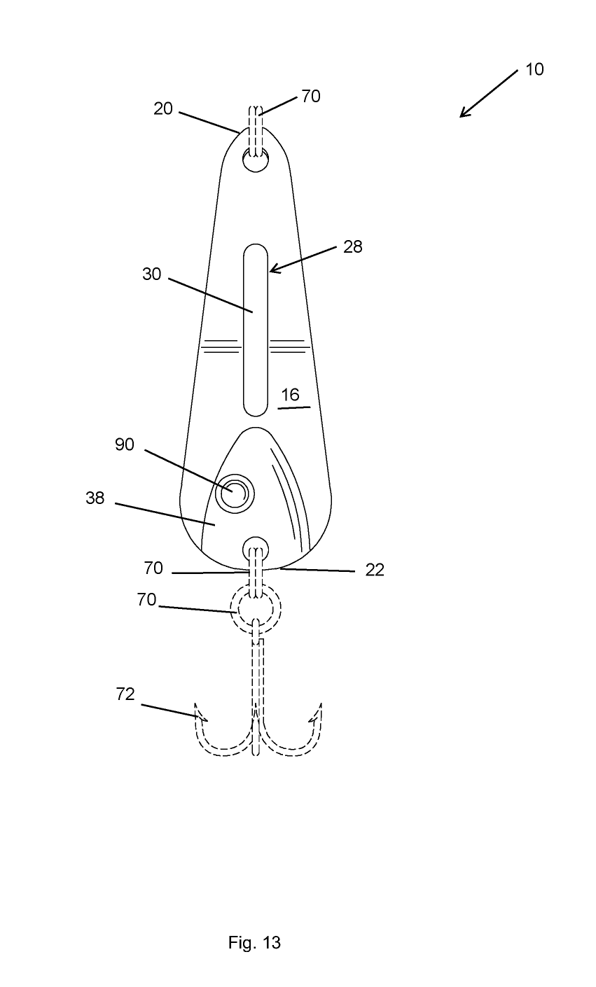

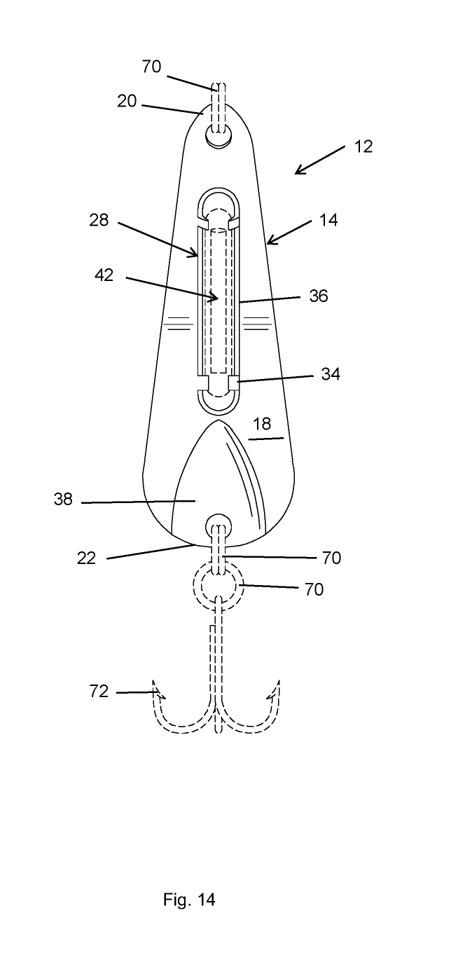

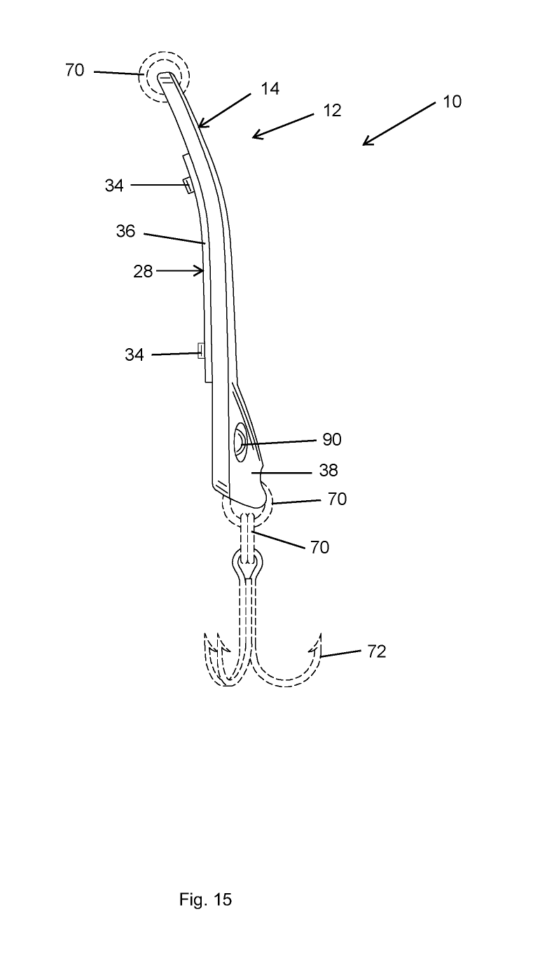

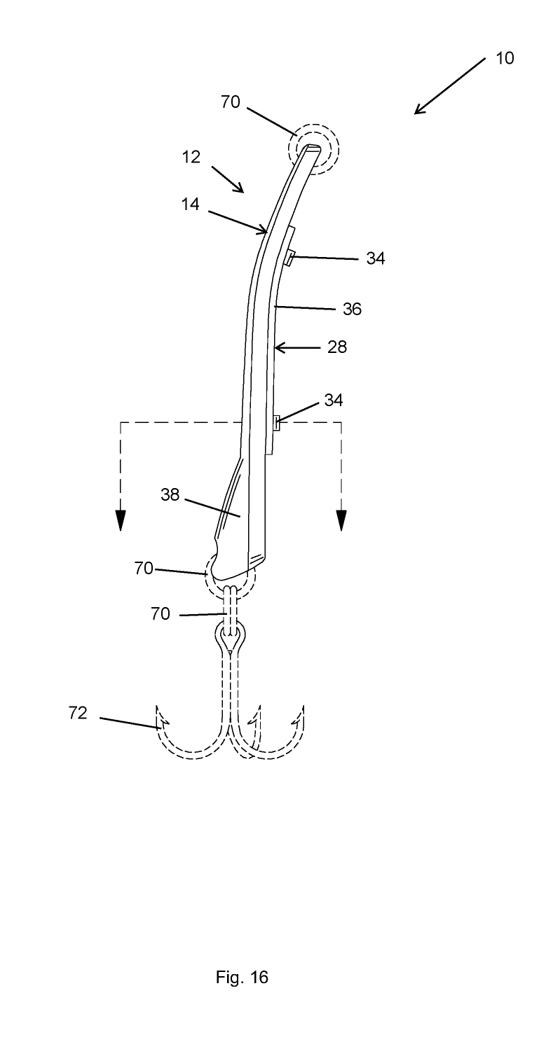

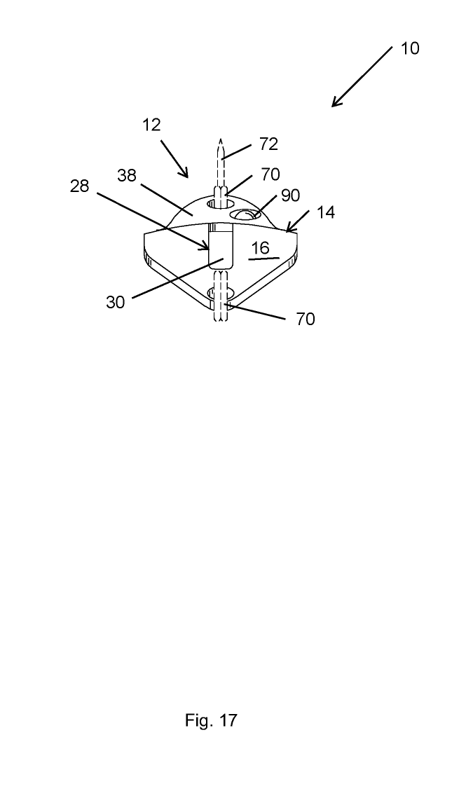

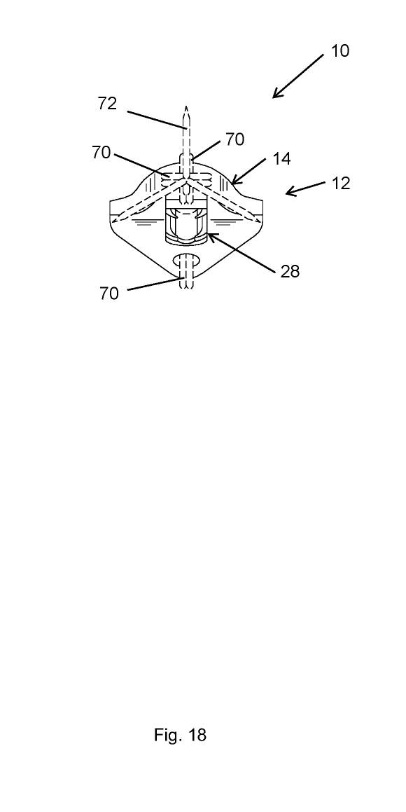

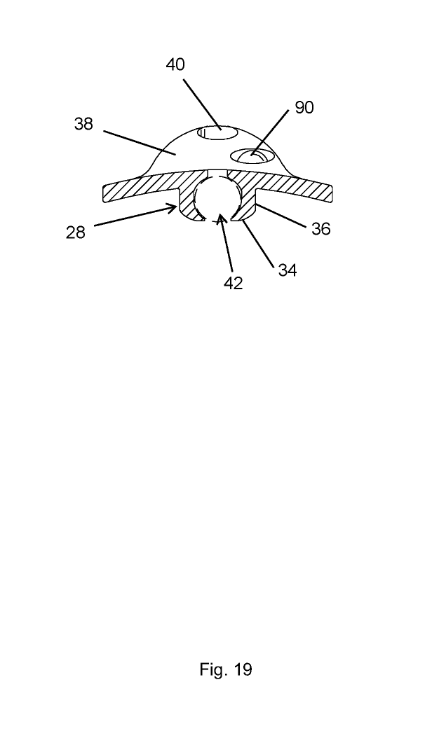

In the arrangement shown, in FIGS. 1-20, receiving member 42 receives light member 42 from the back side 18 of main body 12.

In another, however, receiving member 42 receives light member 42 from the front side 16 and/or the back side 18 such that when light member 42 is inserted within main body 14, light member 42 is held within receiving member 28 by features that engage light member 42 and frictionally hold light member 42 within receiving member 28 between the front side 16 and back side 18. In this arrangement, slots 30 are positioned in the front side 16 and/or the back side 18, and/or the left side 24 and/or right side 26, and/or top side 20 and/or the bottom side 22. In this arrangement, light from light member 42 is visible from the front side 16 and/or the back side 18 (and/or the left side 24 and/or right side 26, and/or top side 20 and/or the bottom side 22) when light member 42 is inserted within the receiving member 28.

In another arrangement, receiving member 42 receives light member 42 from the left side 24 and/or the right side 26 such that when light member 42 is inserted within main body 14, light member 42 is held within receiving member 28 by features that engage light member 42 and frictionally hold light member 42 within receiving member 28 between the left side 24 and right side 26. In this arrangement, slots 30 are positioned in the left side 24 and/or the right side 26, and/or front side 16 and/or the back side 18, and/or top side 16 and bottom side 18. In this arrangement, light from light member 42 is visible from the left side 24 and/or the right side 26 (and/or front side 16 and/or the back side 18, and/or top side 16 and bottom side 18) when light member 42 is inserted within the receiving member 28.

In another arrangement, receiving member 42 receives light member 42 from the top side 20 and/or the bottom side 22 such that when light member 42 is inserted within main body 14, light member 42 is held within receiving member 28 by features that engage light member 42 and frictionally hold light member 42 within receiving member 28 between the top side 20 and bottom side 22. In this arrangement, slots 30 are positioned in the top side 20 and/or the bottom side 22, and/or left side 24 and/or the right side 26, and/or in the front side 16 and/or back side 18. In this arrangement, light from light member 42 is visible from the top side 20 and/or the bottom side 22 (and/or left side 24 and/or the right side 26, and/or in the front side 16 and/or back side 18) when light member 42 is inserted within the receiving member 28, and/or from the front side 16 and/or the back side 18, and/or from the top side 20 and/or the bottom side 22.

Light member 42 may be inserted into and held within receiving member 28 by any other manner, method or means such that light member 42 is frictionally held in place within receiving member 28 of main body 14 and light is allowed to pass from light member 42 outward through slot(s) 30 in main body 14 thereby attracting fish.

One benefit of using a light member 42 that is formed of an elongated cylindrical member with rounded ends 48 is that other than being oriented lengthwise, between ends 48, light member 42 is non-directional. That is, once the ends 48 of light member 42 are aligned with receiving member 28, the light member 42 may be inserted into receiving member 28 without having to further orient light member 42. In addition, the rounded ends 48 of light member 42 facilitate ease of insertion of light member 42 into receiving member 28.

### Alternative Arrangement—Jig Configuration

With reference to FIGS. 20-30 an alternative arrangement is presented wherein lure 12 is a jig. This configuration in FIGS. 20-30 is different than the spoon configuration presented in FIGS. 1-19 in many ways. With that said, there are many similarities. Instead of repeating the teaching above, unless specifically stated otherwise, the teaching related to the spoon configuration, or other configurations of lure 12, is deemed incorporated into the jig configuration presented in FIGS. 20-30.

In the arrangement shown, in FIGS. 20-30, a jig configuration is presented. In this arrangement, hook 72 is what is known as a J-hook having a ring 70 presented at its front side 16 and extending in generally straight fashion rearward therefrom before terminating in the hook-section which includes a point and a barb at its end. In this arrangement, hook 72 is a single, solid and rigid piece extending from ring 70 to the point and barb, which provides superior strength, rigidity and durability. In the arrangement shown, as one example, main body 14 of lure 12 is directly connected to the shaft of hook 72, or said another way, the shaft of hook 72 extends through main body 14 and main body 14 is permanently and rigidity affixed to and with the shaft of hook 72 between ring 70 and the hook section at the end of hook 72. In one arrangement to ensure rigid attachment, the shaft of hook 72 includes features that facilitate connection to the main body 14, so as to ensure that the main body 14 remains rigidly attached to hook 72 and does not slide, spin or otherwise move with respect to hook 72. These features may include a bump, bend, loop, groove, flange or any other feature that interrupts the straight cylindrical shape of the shaft of hook 72 that the material of main body 14 connects to and thereby prevents movement of the main body 14 on hook 72. In one arrangement, main body 14 is molded to and/or around the shaft of hook 72. In another arrangement, main body 14 is placed around hook 72 in a clam-shell like manner with two separate halves that connect to one another. Any other arrangement is hereby contemplated for use.

In the arrangement shown, as one example, main body 14 of lure 12 takes the form of the body of a small fish, having a rounded body when viewed from the side that extends a length along the length of the shaft of hook 72. In the arrangement shown, main body 14 has a generally straight back line that extends on one side of the shaft of hook 72. A rounded surface connects to this straight back line at its forward 16 and rearward 18 ends and extends from its nose, along the belly to its tail. Eye 90 positioned in the sides of main body 14 at its forward end 16, and receiving member 28 extends along a length of main body 14 in approximate parallel spaced relation to the length of the shaft of hook 72 positioned a distance below the shaft on a side opposite of the back line. In this arrangement, the hook portion of hook 72 extends out of the back side 18 of main body 14 and curves upward such that the point and barb of hook 72 are positioned above the back line of the main body 14 and point forward in approximate parallel spaced relation to the back line and the length of the shaft of hook 72.

In the arrangement shown, as one example, the belly of main body 14 is wider than the back line of main body 14. Or, said another way, main body 14 widens as it extends vertically from the back line to the belly. In this arrangement, as more material is positioned at the bottom side 22, along the belly, than there is along the top side 20, along the back line, this causes the jig lure 12 to swim in an upright manner, with the belly below the back line due to the center of gravity being positioned toward the belly.

As is described herein, main body 14 includes a receiving member 28 that receives a light member 42 therein. In one arrangement, receiving member 28 includes a slot on one side of main body 14 and includes a smaller slot on the opposite side of main body 14 that allows light there to pass there through while preventing the light member 42 from passing there through. Alternatively, main body 14 includes a slot 30 on one side that allows insertion of the light member 42 into the main body 14 and then includes only one circular opening, two circular openings, three circular openings, or more circular openings in the opposite side of the main body 14, or alternatively these openings are formed of any other shape such as square, rectangular, triangular, pentagonal, hexagonal, heptagonal, octagonal, oval or any other shape. In another arrangement, there are no openings in opposite side of the main body 14 from the side that receives the light member 42. In an alternative arrangement, light member 42 is inserted within the main body 14 through a hole or opening in the front side 16 or back side 18 of main body 14 or in any other portion of main body 14.

While in the arrangement shown, light member 42 is held within the main body 14 of lure 12, in an alternative arrangement light member 42 is not held in the interior of main body 14. Instead, in this arrangement, light member 42 is held in an exterior arrangement to main body 14. In one arrangement, light member 42 is held exterior to main body 14 along the back line of main body 14 and is held by at least one pair of opposing fingers, like fingers 34, that extend outward from main body 14 adjacent the top side 20. In one arrangement, two pairs of fingers 34 are placed along the back line, one pair intended to engage the forward end of light member 42 and other pair intended to engage the rearward end of light member 42. Any number of opposing pairs of fingers 34 is contemplated for use. In this way, light member 42 is held proud or, or external to, main body 14, which provides greater visibility to light member 42 and a brighter illumination as light generated by light member is not captured within main body 14. In an alternative arrangement, light member 42 is held exterior to main body 14 along the belly of main body 14 and is held by at least one pair of opposing fingers, like fingers 34, that extend outward from main body 14 adjacent the bottom side 22. In an alternative arrangement, light member 42 is held exterior to main body 14 along the left side 24 and/or the right side 26 of main body 14 and is held by at least one pair of opposing fingers, like fingers 34, that extend outward from main body 14 adjacent the bottom side 22. Any number of pairs of opposing fingers 34 may be positioned at any place along the exterior surface of main body 14 to attach any number of light members 42 at any position. This may be in combination with receiving member 28 within main body 14.

As an example, a light member 42 may be attached to both the top side 20 along the back line and a light member 42 may be attached to the bottom side 22 along the belly. As another example, a light member 42 may be attached to the left side 24 and the right side 26. As another example, a light member 42 may be attached to both the top side 20 along the back line, a light member 42 may be attached to the bottom side 22 along the belly, a light member 42 may be attached to the left side 24 and the right side 26. By placing pairs of opposing fingers 34 at different places along the exterior surface of main body 14 this provides the user with the option to attach light members 42. As an example, while a lure 12 may have five places where a light member 42 may be attached (receiving member 28 within main body 12 and pairs of opposing fingers 34 at the top side 20, bottom side 22, left side 24 and right side 26) the user can attach only the desired number of light members 42 depending on their application and the conditions. As an example, when the water is clear, only a single light member 42 may be attached as that is all that is needed to provide adequate illumination. In contrast, when the water is murky perhaps attaching multiple light members 42 may be needed. In addition, attaching light members 42 in different positions on lure 12 may provide a different appearance and action and effect.

This arrangement provides a number of advantages over the spoon arrangement presented in FIGS. 1-19. Namely the action or movement of the jig arrangement is substantially different than the spoon arrangement and therefore this jig arrangement is useful in many other and different applications than the spoon arrangement. Also, the ring 70 and hook 72 are rigidly attached to the main body 14 which provides a different arrangement, configuration, action and use of lure 12. That is, the rigid attachment of ring 70 to hook 72 to main body 14 provides a strong, rigid and durable member that receives light member 42. In addition, the attachment of light member 42 to the main body 14 of the jig provides the same benefits as that of the spoon—that is it attracts and catches fish.

### Rattling Component

To attract the attention of fish, in one arrangement, lure 12, whether it is a jig or a spoon, includes a rattling component. Rattling component is formed of any suitable size, shape and design and is configured to create noise, or rattling, when the lure 12 is moved through the water. This rattling has the effect of attracting the attention of fish and can cause the fish to strike. In one arrangement, rattling component is an open portion in main body that houses one or more movable members, such as ball bearings or the like, that move when lure 12 moves thereby creating a rattling sound. In another arrangement, the rattling component is attached to, connected to, inserted within or otherwise associated with lure 12. In one arrangement, rattling component may be connected to the main body 14 of lure 12 much in the same way or ways that light member 42 is attached to main body 14 as is described herein. By making the rattling component attachable and detachable this allows the user to add and remove the rattling component as desired and provides the user with increased flexibility and control over the lure 12.

From the above discussion it will be appreciated that the glow in the dark fishing lure system presented herein improves upon the state of the art.

Specifically, the glow in the dark fishing lure system presented: provides a bright glow that attracts fish; increases the amount of fish caught; glows for a long period of time; can be used in various environmental conditions, such as cold water, while effectively operating; is easy to use; is safe to use; does not require the user to repeatedly grasp the fishing lure for recharging using a light source; has a long useful life; can be effectively used for ice fishing; is relatively inexpensive; allows for the simple and easy replacement of a glow in the dark cartridge; is fun to use; shines with a brilliant light; can be used with various fishing lure sizes, shapes and configurations; can be modified to illuminate with any of a number of colors by simply changing a cartridge; can brightly shine for hours; improves over existing glow in the dark fishing lures; is strong and robust; can be used in many applications; provides unique functionality; is fast to use; saves time; has a compact size; has a low profile; is high quality; improves efficiencies; improves enjoyment, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A glow in the dark fishing lure system, comprising:
a lure;
the lure having a main body;
the main body having a front side, a back side, a top side, and a bottom side;
at least one hook operatively connected to the main body;
a receiving member positioned in the main body;
a light member;
the light member configured to glow when activated;
the light member having a size and shape that is configured to connect with the receiving member of the main body;
wherein when the light member is connected with the receiving member the receiving member frictionally holds the light member in place during use;
wherein when the light member is activated and connected with the receiving member a glow in the dark fishing lure is formed.

2. The system of claim 1, wherein the receiving member includes a slot, wherein the slot extends within the main body a distance wherein the light member is inserted into the receiving member through the slot in the receiving member.

3. The system of claim 1, wherein the light member is formed of a glow stick.

4. The system of claim 1, wherein the light member includes a cylindrical body.

5. The system of claim 1, further comprising a stop member operably connected to the receiving member, wherein the stop member extends inward a distance into the receiving member, wherein the stop member is configured to stop the light member from passing through the receiving member.

6. The system of claim 1, further comprising a stop member operably connected to the receiving member, wherein the stop member extends inward a distance into the receiving member, wherein the stop member forms a lip that extends around a side of the receiving member, wherein the stop member is configured to stop the light member from passing through the receiving member.

7. The system of claim 1, further comprising at least one finger operably connected to the receiving member, wherein the at least one finger extends inward a distance into the receiving member, wherein the at least one finger is configured to hold the light member in the receiving member.

8. The system of claim 1, further comprising a stop member positioned on a first side of the receiving member and at least one finger positioned on a second side of the receiving member, wherein the first side is opposite the second side; wherein when the light member is positioned within the receiving member the light member is held between the stop member and the at least one finger.

9. The system of claim 1, wherein the light member is held between a stop member on one side of the receiving member and a finger on an opposite side of the slot.

10. The system of claim 1, wherein when the receiving member includes at least one pair of opposing fingers, wherein the light member is held in place between the at least one pair of opposing fingers.

11. The system of claim 1, wherein the main body is in the form of a spoon.

12. The system of claim 1, wherein the main body is in the form of a jig.

13. A glow in the dark fishing lure system, comprising:
a lure;
the lure having a main body;
the main body having a front side, a back side, a top side, and a bottom side;
at least one hook operatively connected to the main body;
a receiving member positioned in the main body;
the receiving member having at least one opening that extends through a portion of the main body;
the receiving member having a stop member positioned on a first side of the receiving member;
the receiving member having at least one finger positioned on a second side of the receiving member, opposite the first side;
a light member;
the light member configured to glow when activated;
the light member having a size and shape that is configured to connect with the receiving member of the main body;
wherein the light member is held in place within the receiving member between the stop member on a first side of the light member, and the at least one finger on an second side of the light member, opposite the first side.

14. The system of claim 13, wherein the receiving member extends within the main body.

15. The system of claim 13, wherein the light member is formed of a glow stick.

16. The system of claim 13, wherein the light member includes a cylindrical body.

17. The system of claim 13, wherein the stop member extends inward a distance into the receiving member, wherein the stop member is configured to stop the light member from passing through the receiving member.

18. The system of claim 13, wherein the main body is in the form of a spoon.

19. The system of claim 13, wherein the main body is in the form of a jig.

20. A glow in the dark fishing lure system, comprising:
a lure;
the lure having a main body;
the main body having a front side, a back side, a top side, and a bottom side;
at least one hook operatively connected to the main body;
a receiving member positioned in the main body;
a light member;
the light member configured to glow when activated;
the light member having a size and shape that is configured to connect with the receiving member of the main body;
a removal tool;
the removal tool having a main body and a protrusion that extends outward from the main body;
wherein the protrusion is configured to fit within the receiving member;
wherein the light member is removed from the receiving member by inserting the protrusion within the receiving member thereby pushing the light member out of the receiving member.

21. A glow in the dark fishing lure kit, the kit comprising:
a lure;
the lure having a main body;
the main body having a front side, a back side, a top side, and a bottom side;
at least one hook operatively connected to the main body;
a receiving member positioned in the main body;
a light member;
the light member configured to glow when activated;
the light member having a size and shape that is configured to connect with the receiving member of the main body;
a removal tool;
the removal tool having a main body and a protrusion that extends outward from the main body;
wherein the protrusion is configured to fit within the receiving member to facilitate removal of the light member from the receiving member.

22. A method of forming a glow in the dark fishing lure, the steps comprising:
providing a lure having a main body having a front side, a back side, a top side, and a bottom side, at least one hook operatively connected to the main body, a receiving member positioned in the main body;
providing light member, wherein the light member is a glow stick;
activating the light member such that the light member glows;
inserting the light member into the receiving member of the main body;
holding the light member within the receiving member during use;
using the combined lure and light member as a glow in the dark fishing lure.

23. A glow in the dark fishing lure system, comprising:
a lure;
the lure having a main body;
at least one hook operatively connected to the main body;
a receiving member positioned in the main body;
the receiving member having an opening that is configured to receive a light member therein;
a light member;
the light member configured to glow when activated;
the light member having a size and shape that is configured to connect with the receiving member of the main body;
wherein when the light member is connected with the receiving member the receiving member frictionally holds the light member in place during use;
wherein when the light member is activated and connected with the receiving member a glow in the dark fishing lure is formed;
wherein when the light member is activated and connected with the receiving member light from the light member shines outward from the main body.
